(19) United States
(12) Patent Application Publication
(10) Pub. No.: US 2016/0078476 A1
(43) Pub. Date: Mar. 17, 2016

(54) INFORMATION PROCESSING APPARATUS, INFORMATION PROCESSING METHOD, AND RECORDING MEDIUM

(71) Applicant: KABUSHIKI KAISHA TOSHIBA, Tokyo (JP)

(72) Inventor: Eiichi SUNAGAWA, Yokohama (JP)

(21) Appl. No.: 14/851,971

(22) Filed: Sep. 11, 2015

(30) Foreign Application Priority Data
Sep. 17, 2014 (JP) 2014-189345

(51) Int. Cl. G06Q 30/02

(52) U.S. Cl. CPC G06Q 30/0247; G06Q 30/0246

(57) ABSTRACT

According to one embodiment, an information processing apparatus includes a data collector which collects a plurality of pieces of data. The information processing apparatus includes a discontinuation determiner which compares, for each data or the whole processing of collecting the plurality of pieces of data, an invested cost that is already invested for data collection and an allowable investment cost that is an upper limit of a cost allowed to be invested for the data collection and, according to a comparison result, determines to discontinue the data collection. The information processing apparatus also includes a content determiner which, when the discontinuation determiner determines to discontinue the data collection, uses the data collected by the data collector up to a point when the discontinuation is determined and determines information relevant to a content to be distributed.

### CROSS REFERENCE TO RELATED APPLICATION(S)

This application is based upon and claims the benefit of priority from the prior Japanese Patent Application No. 2014-189345, filed on Sep. 17, 2014, the entire contents of which are incorporated herein by reference.

### FIELD

Embodiments described herein relate generally to an information processing apparatus, an information processing method, and an recording medium.

### BACKGROUND

In recent years, an electronic billboard (digital signage) being an advertising medium is set up in a station and in town to display video or text information with use of a flat panel display, a projector and the like while utilizing digital technology for display and communication. Some of recent digital signage system not only distribute contents according to a predetermined schedule but also dynamically collect information relevant to a target person to whom the contents are distributed (target of distribution) and selects more effective contents for the target before distribution.

In general, however, the information relevant to the target of distribution is not always collected instantaneously, and thus the target of distribution tends to shift his attention when it takes too long to collect the information. It is therefore unpreventable to result in a situation where the target of distribution may not view the contents unless in a situation advantageous to keep the attention of the target of distribution to a digital signage terminal until information collection processing is completed (such as a situation where one waits for printing to be done by a copier or one waits at a checkout counter).

On the other hand, a strategy aiming only at achievement of content distribution, for example, to select the contents once any one of information to be collected is acquired without allowing time for other information, causes an unpreventable situation where non-optimal contents are selected when inferior information such as wrong information or information, the use of which does not affect the outcome, arrives first.

There is a trade-off between usability of information (hereinafter simply abbreviated as usability) and an information acquisition cost (hereinafter simply abbreviated as a cost). Here, the usability refers to a difference in an expected effect (such as a purchase probability and accuracy thereof) that changes upon use of the data. The cost refers to an amount of matter (such as time, energy, or money) used in the process of collecting the data.

Accordingly, there is a trade-off between an invested time and an advantage of content determination or between the invested time and content reachability, where the content distribution pursuing either one of these possibly results in degraded cost effectiveness in the long run. While the aforementioned example focuses on the elapsed time, in general, there is a trade-off between determining contents under an advantageous situation and determining contents at a lower cost, where various costs such as energy and money in addition to the temporal cost described above cause a similar problem.

By selecting and distributing contents based on more data as information, a digital signage system works more effectively. However, the data acquisition cost is not always fixed but varies or results in a delay depending on its kind or situation, so that the cost effectiveness is degraded in a system that places importance on acquiring useful data without considering the cost.

On the other hand, by lowering the cost invested to determine the contents, the cost effectiveness can be improved. The data usability however is not always the same, so that it is unpreventable for low effective contents to be selected in a system that places importance on data available at low cost even when more effective contents can be selected by adding different data.

### BRIEF DESCRIPTION OF THE DRAWINGS

FIG. 1 is a schematic view illustrating an overview of processing performed in each embodiment;

FIG. 2 is a table illustrating an example of data managed in a member age database;

FIG. 3 is a table illustrating an example of data managed in a member gender database;

FIG. 4 is a table illustrating an example of data managed in an event database;

FIG. 5 is a table illustrating an example of data managed in a weather database;

FIG. 6 is a diagram illustrating a hardware configuration of an information processing apparatus 1 according to a first embodiment;

FIG. 7 is a functional block diagram of the information processing apparatus 1 according to the first embodiment;

FIG. 8 is a flowchart illustrating an example of a flow of processing performed according to the first embodiment;

FIG. 9 is a table illustrating an example of data of an allowable investment cost stored in an allowable investment cost storage 22;

FIG. 10 is a table illustrating an example of an elapsed time until each data is acquired;

FIGS. 11A to 11C are tables each illustrating an example of data stored in a data storage 21;

FIGS. 12A to 12D are tables each illustrating an example of a cost stored in a cost storage 23;

FIG. 13 is a table illustrating an example of correspondence between a combination of data and a content held by a content determiner 44;

FIG. 14 is a functional block diagram of an information processing apparatus 1 according to a second embodiment;

FIG. 15 is a flowchart illustrating an example of a part of a flow of processing performed according to the second embodiment;

FIG. 16 is a table illustrating an example of each allowable investment cost recorded in an allowable investment cost storage 22;

FIG. 17 is a flowchart illustrating an example of a part of a flow of processing performed according to a third embodiment;

FIG. 18 is a table illustrating an example of data of a past acquisition cost in past content distribution, the data being stored in a cost storage 23;

FIG. 19 is a table illustrating an example of an allowable investment cost stored in an allowable investment cost storage 22;

FIG. 20 is a table illustrating an example of data recorded in a data storage 21 in past content distribution;

FIG. 21 is a flowchart illustrating an example of a part of a flow of processing performed according to a fourth embodiment;

FIGS. 22A and 22B are tables each illustrating an example of an allowable investment cost according to the fourth embodiment;

FIG. 23 is a functional block diagram of an information processing apparatus 1 according to a fifth embodiment;

FIG. 24 is a table illustrating an example of data stored in an effect storage 24;

FIG. 25 is a flowchart illustrating an example of a part of a flow of processing performed according to the fifth embodiment;

FIG. 26 is a table illustrating an example of data representing cost effectiveness;

FIG. 27 is a table illustrating an example of an allowable investment cost determined in the fifth embodiment;

FIG. 28 is a flowchart illustrating an example of a part of a flow of processing performed according to a sixth embodiment;

FIG. 29 is a table illustrating an example of an allowable investment cost determined in the sixth embodiment;

FIG. 30 is a functional block diagram of an information processing apparatus 1 according to a seventh embodiment;

FIG. 31 is a flowchart illustrating an example of a part of a flow of processing performed according to the seventh embodiment;

FIG. 32 is a table illustrating an example of a pair of a predicted cost and a predicted incidence when age data “70” is acquired as acquired data;

FIG. 33 is a table illustrating an example of a pair of a cost and an expected value of cost effectiveness when the age data “70” is acquired as the acquired data;

FIG. 34 is a table illustrating an example of an allowable investment cost according to the seventh embodiment;

FIG. 35 is a table illustrating an example of a track record of past content distribution;

FIG. 36 is a flowchart illustrating an example of processing which determines the allowable investment cost while factoring in an effect of distribution; and

FIG. 37 is a flowchart illustrating an example of processing which determines the allowable investment cost while factoring in the acquired data.

### DETAILED DESCRIPTION

Embodiments will now be explained with reference to the accompanying drawings. The present invention is not limited to the embodiments.

According to one embodiment, an information processing apparatus includes a data collector which collects a plurality of pieces of data. The information processing apparatus includes a discontinuation determiner which compares, for each data or the whole processing of collecting the plurality of pieces of data, an invested cost that is already invested for data collection and an allowable investment cost that is an upper limit of a cost allowed to be invested for the data collection and, according to a comparison result, determines to discontinue the data collection. The information processing apparatus also includes a content determiner which, when the discontinuation determiner determines to discontinue the data collection, uses the data collected by the data collector up to a point when the discontinuation is determined and determines information relevant to a content to be distributed.

Embodiments of the present invention will now be described with reference to the accompanying drawings. In each embodiment, a cost of collecting each data is recorded one by one so as to discontinue the collection of data before exceeding an upper limit of the cost allowed to be invested (hereinafter referred to as an allowable investment cost) and select and start distributing a content. As described above, the cost refers to an amount of matter (such as time, energy, or money) used in the process of collecting the data.

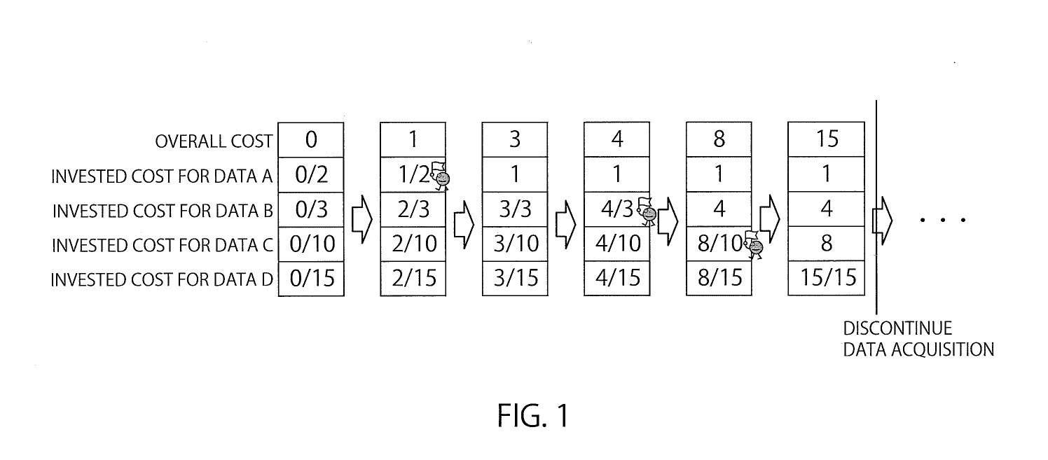

An overview of processing performed in each embodiment will be described with reference to FIG. 1. FIG. 1 is a schematic view illustrating the overview of the processing performed in each embodiment. FIG. 1 illustrates an example of a transition over time of an overall cost as well as an invested cost already invested to collect each of data A, B, C, and D. Each cost represents time in this case. Moreover, the cost is expressed as “an invested cost for target data/allowable investment cost set for target data” at a time point when the target data is not yet acquired.

In the example of FIG. 1, the data A is acquired when the invested cost equals 1. As for the data B, the invested cost equals the allowable investment cost set for the data B when the invested cost equals 3, but the collection of the data B continues as the data C and D are not yet acquired at this point. The data B is acquired when the invested cost equals 4. The data C is acquired when the invested cost equals 8. The data D is not yet acquired when the invested cost thereof equals 15 which is the allowable investment cost set for the data D, whereby the collection of the data D is discontinued. The information processing apparatus therefore determines a content by using three pieces of data including the data A, B, and C.

Moreover, each embodiment will be described by using an example where, when a card reader provided in a retail store reads a membership card of a shopper, the information processing apparatus of each embodiment selects an advertising content and distributes the advertising content to a digital signage terminal placed adjacent to the card reader. The shopper viewing the advertising content evaluates the advertisement by pressing a “like” button on the digital signage terminal, the button being pressed more times as the advertisement is rated higher.

The card reader provided in the retail store is assumed to be equipped with a clock function, a location registration function, and an external communication function. In the information processing apparatus of each embodiment, “12/20” is registered as current date data and “Kawasaki” as location data, for example.

The card reader acquires preregistered location data, current date data, and member ID data upon reading the membership card of the shopper. The card reader then uses the member ID data to inquire of external customer age database and customer gender database, and additionally acquires age data and gender data of the shopper whose card is read. Every time the data is acquired, the card reader transmits a set of a data type, data, and a cost to a data collector included in the information processing apparatus.

At the same time, the card reader uses the location data and the current date data to inquire of external weather database and event database, and additionally acquires weather data and event data corresponding to the same location and date. Every time the data is acquired, the card reader transmits the set of a data type, a data value, and a cost one set at a time to the data collector included in the information processing apparatus.

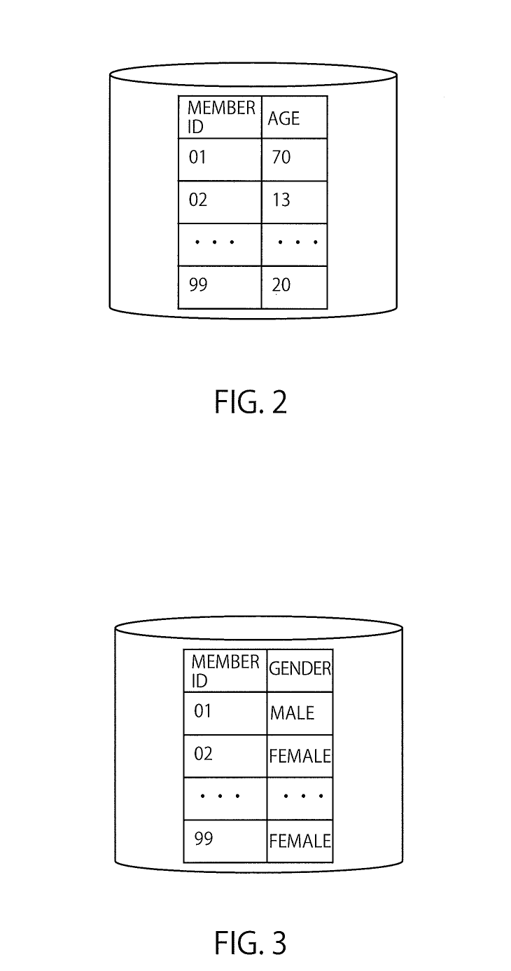

The card reader communicates with an external database such as a member age database (FIG. 2) which stores a pair of a member ID identifying a member and a member's age. FIG. 2 is a table illustrating an example of data managed in the member age database. As illustrated in FIG. 2, the member ID and the member's age are associated with each other.

Another example of the external database is a member gender database (FIG. 3) which stores a pair of the member ID and a member's gender. FIG. 3 is a table illustrating an example of data managed in the member gender database. As illustrated in FIG. 3, the member ID and the member's gender are associated with each other.

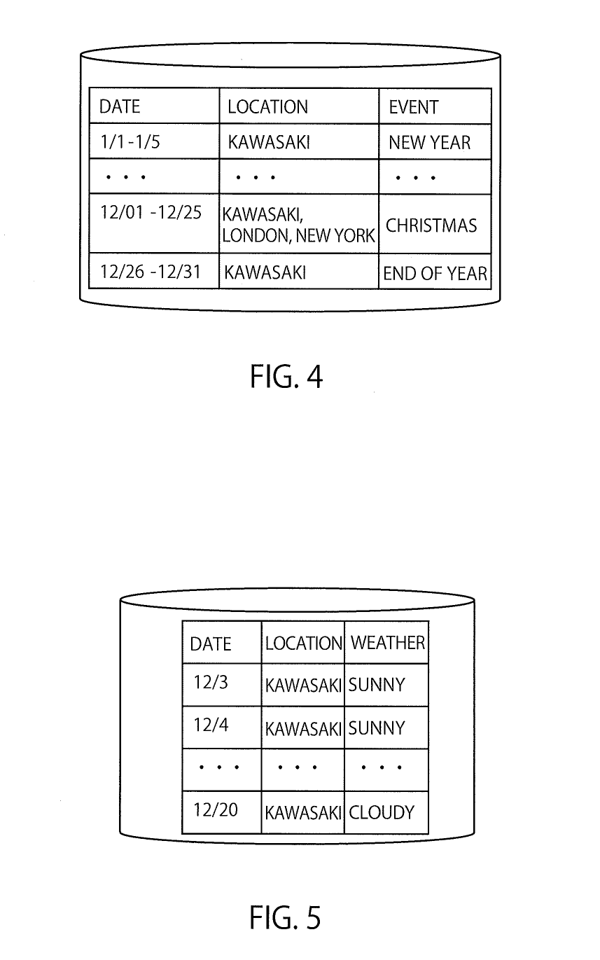

Another example of the external database is an event database (FIG. 4) which stores a set of a date, a location and an event. FIG. 4 is a table illustrating an example of data managed in the event database. As illustrated in FIG. 4, the date, location, and event are associated with one another.

Another example of the external database is a weather database (FIG. 5) which stores a set of a date, a location and weather. FIG. 5 is a table illustrating an example of data managed in the weather database. As illustrated in FIG. 5, the date, location, and weather are associated with one another.

### First Embodiment

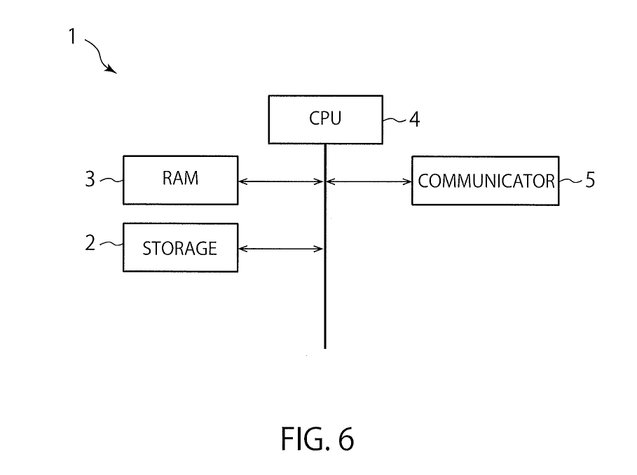

A first embodiment will be described. FIG. 6 is a diagram illustrating a hardware configuration of an information processing apparatus 1 according to the first embodiment. As illustrated in FIG. 6, the information processing apparatus 1 includes a storage 2, a RAM (Random Access Memory) 3, a CPU (Central Processing Unit) 4, and a communicator 5.

The storage 2 stores various data and a program to be read and executed by the CPU 4. The storage 2 is a hard disk, for example.

The RAM 3 temporarily stores information.

The CPU 4 executes a program by reading the program from the storage 2 to the RAM 3.

The communicator 5 communicates with the card reader. The communication may be wired or wireless.

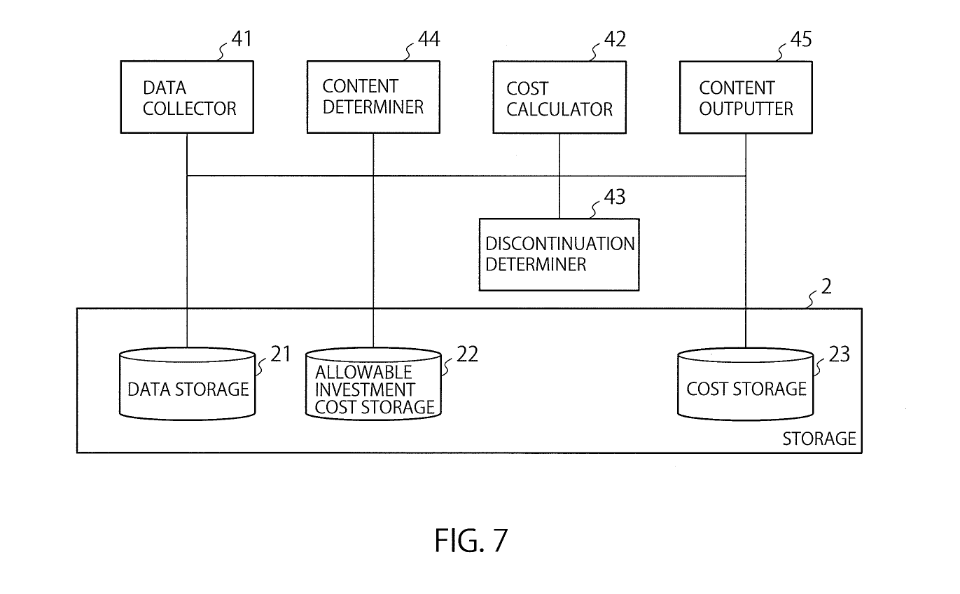

Next, a functional configuration of the information processing apparatus 1 according to the first embodiment will be described with reference to FIG. 7. FIG. 7 is a functional block diagram of the information processing apparatus 1 according to the first embodiment. As illustrated in FIG. 7, the CPU 4 creates on the RAM 3 a data collector 41, a cost calculator 42, a discontinuation determiner 43, a content determiner 44, and a content outputter 45 upon reading the program from the storage 2 to the RAM 3 and executing the program.

The storage 2 includes a data storage 21, an allowable investment cost storage 22, and a cost storage 23.

The data storage 21 holds data collected by the data collector 41. The data storage 21 may hold the data by using an electronic file, a database, or another means. The data storage 21 holds a distribution ID indicating a segment of content distribution executed as well as the age data, gender data, event data, and weather data collected by the data collector 41 in a CSV file format, for example. A new line is added to the CSV file every time the content distribution is executed.

The allowable investment cost storage 22 holds an allowable investment cost that is preset for each data.

The allowable investment cost storage 22 may store the allowable investment cost by using an electronic file, a database, or another means. The allowable investment cost storage 22 holds the entire process, age data, gender data, event data, and weather data in the CSV file format, for example.

The data collector 41 collects a plurality of pieces of data. In the present embodiment, as an example, the data corresponds to any one of an attribute of a person to whom a content is distributed, an event related to a time point when the data is collected, and weather at a time point when the data is collected.

In the present embodiment, for example, the data collector 41 acquires data used to determine a content and a cost of the data, and stores them in the data storage 21. The data collector 41 may collect the data by acquiring data transmitted by another device or executing processing to acquire data. The data collector 41 receives the set of a data type, a data value, and a cost transmitted from the card reader one set at a time by communication through a network, for example.

The cost calculator 42 monitors a data acquisition process and, every time an invested cost increases, calculates an invested cost for the entire process and each data. The cost calculator 42 then stores the invested cost calculated for the entire process and each data into the cost storage 23. The cost calculator 42 treats time as a cost, for example, and measures time taken for each data to be acquired since first piece of data is acquired by the data collector 41. While a cost of the entire process always corresponds with a cost of unacquired data when time is treated as the cost, there is a case where a sum of costs of each data corresponds with the cost of the entire process such as when electrical power of a sensor group independently operating to acquire each data is treated as the cost, for example.

The cost storage 23 holds the invested cost calculated for each data by the cost calculator 42. The cost storage 23 may store the data acquisition cost by using an electronic file, a database, or another means. The cost storage 23 saves the distribution ID indicating the segment of content distribution executed as well as an invested cost of each of the age data, gender data, event data, and weather data output by the cost calculator 42 in the CSV file format, for example. A new line is added to the CSV file every time the content distribution is executed. A value of data not used in determining a content is updated as a blank.

The discontinuation determiner 43 compares, for each data or the whole processing of collecting the plurality of pieces of data, the invested cost that is already invested for data collection and the allowable investment cost that is an upper limit of the cost allowed to be invested for the data collection and, according to a comparison result, determines to discontinue the data collection. The allowable investment cost is set for each of the plurality of pieces of data. Accordingly, the discontinuation determiner 43 particularly compares, for each data, the invested cost that is already invested for the data collection and the allowable investment cost set for the data.

Specifically, for example, the discontinuation determiner 43 checks an update of data recorded in the data storage 21 and, at a timing when there is no more unacquired data, transmits to the content determiner 44 a discontinuation signal provided for the content determiner 44 to determine and distribute a content. The discontinuation determiner also checks an update in the cost calculator 42, compares the invested cost calculated by the cost calculator 42 and the allowable investment cost held in the allowable investment cost storage 22, and determines to discontinue the data collection according to an algorithm to be described. When determining to discontinue the data collection, the discontinuation determiner 43 transmits the discontinuation signal to the content determiner 44.

The discontinuation determiner 43 determines to discontinue the data collection when there is no more unacquired data or when the unacquired data exists but the invested cost already invested for the entire process or for acquiring the unacquired data exceeds the corresponding allowable investment cost, for example. The data collection continues otherwise.

When the discontinuation determiner 43 determines to discontinue the data collection, the content determiner 44 uses the data collected by the data collector 41 up to a point when the discontinuation is determined and determines information relevant to a content to be distributed. Here, the information relevant to the content corresponds to at least one of a content, a way the content is distributed (such as a timing and a communication path), and a way the content is displayed (such as a display position and a display time). The information relevant to the content refers to the content, as an example, in the present embodiment described below.

Next, the processing performed by the content determiner 44 will be described while using a specific example of operation. When receiving the discontinuation signal from the discontinuation determiner 43, for example, the content determiner 44 acquires data held in the data storage 21 and selects a content by using the acquired data. The content is thus selected at a timing determined by the discontinuation determiner 43.

Here, the content may be selected from a content preregistered in the content determiner 44 or a content registered in another device. Three contents including a jewelry advertisement, a toy advertisement, and a New Year's decoration advertisement are preregistered in the content determiner 44, for example, where the content determiner 44 uses the age data, gender data, event data, and weather data held in the data storage 21 to select one of the registered contents.

The content determiner 44 transmits the selected content to the content outputter 45.

As a result, the content outputter 45 distributes the selected content to a distribution destination. The content outputter 45 for example outputs the selected content to a digital signage terminal, which then displays the content.

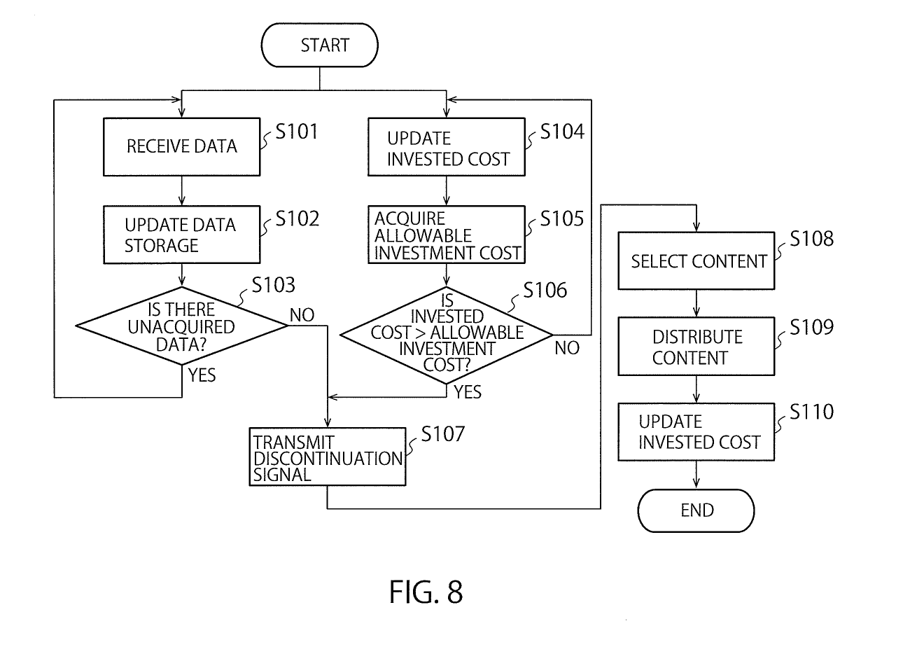

Next, a flow of the processing performed in the first embodiment will be described with reference to FIG. 8. FIG. 8 is a flowchart illustrating an example of the flow of processing performed according to the first embodiment. The flow of overall processing performed by the information processing apparatus 1 will now be described by using specific data as an example. The distribution ID is set to 0001 at this time.

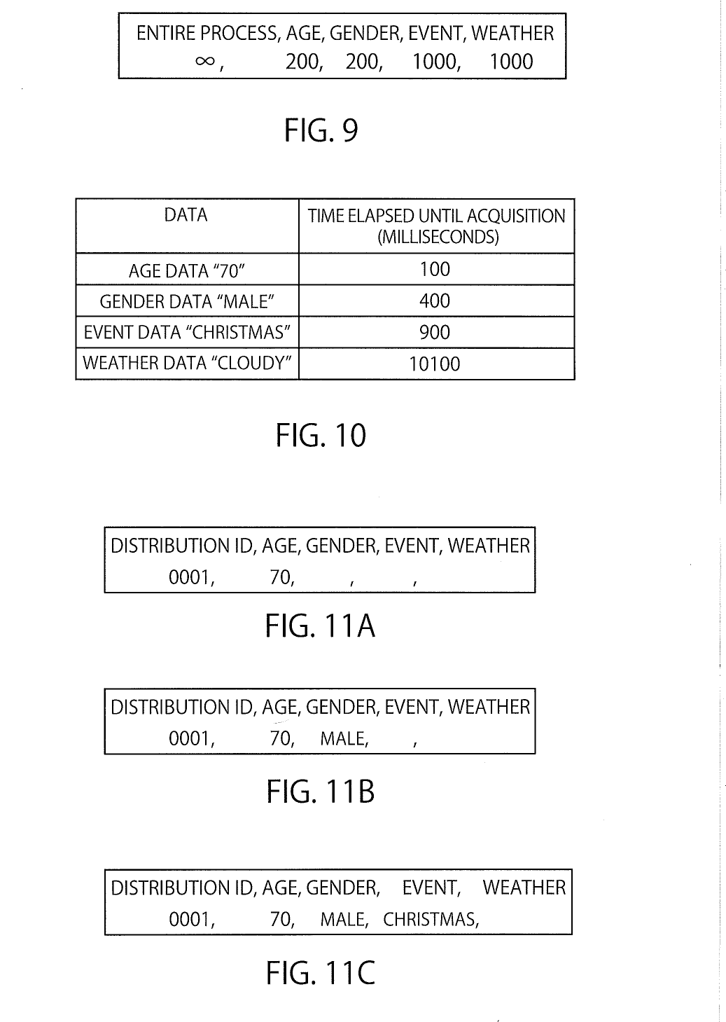

FIG. 9 is a table illustrating an example of data of the allowable investment cost stored in the allowable investment cost storage 22. In the present embodiment, as illustrated in FIG. 9, the allowable investment cost storage 22 stores in advance the allowable investment costs “∞, 200, 200, 1000, 1000” (in milliseconds) of the entire process, age data, gender data, event data, and weather data in the CSV file format, respectively. Here, the symbol “∞” is a symbol always determined to be larger than a target of comparison. The allowable investment cost will be hereinafter expressed as “an allowable investment cost for the entire process, an allowable investment cost for the age data, an allowable investment cost for the gender data, an allowable investment cost for the event data, and an allowable investment cost for the weather data”.

The card reader reads a member ID “01”, for example, and uses the ID to acquire age data “70” from the customer age database and gender data “male” from the customer gender database. Moreover, the card reader uses the date data “12/20” and the location data “Kawasaki” to acquire event data “Christmas” from the event database and “cloudy” from the weather database.

FIG. 10 illustrates the elapsed time until each data is acquired.

FIG. 10 is a table illustrating an example of the elapsed time until each data is acquired. As illustrated in FIG. 10, for example, the elapsed time until the age data “70” is acquired is 100 milliseconds, and the elapsed time until the gender data “male” is acquired is 400 milliseconds. The elapsed time until the event data “Christmas” is acquired is 900 milliseconds, and the elapsed time until the weather data “cloudy” is acquired is 10100 milliseconds.

Every time a new piece of data is acquired, the card reader transmits a set of a data type and a data value to the data collector 41 one set at a time.

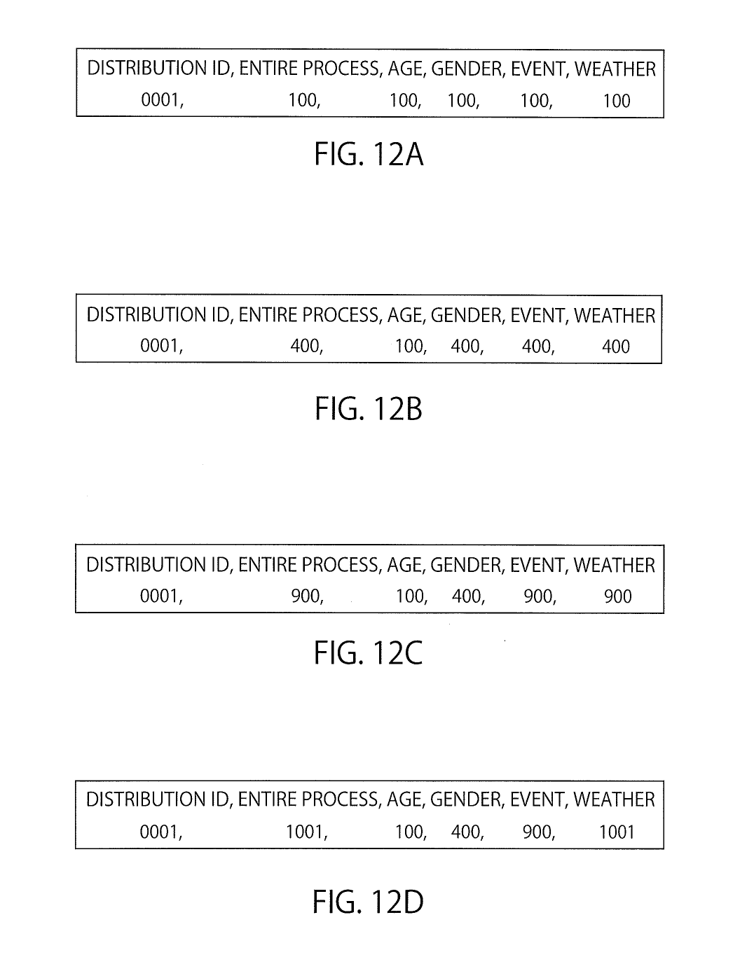

Referring back to the flowchart in FIG. 8, the execution of step S101 and step S104 are started concurrently right after the processing is started. The flow of processing will be described with reference to FIGS. 11 and 12. FIGS. 11A to 11C are tables each illustrating an example of data stored in the data storage 21. FIGS. 12A to 12D are tables each illustrating an example of a cost stored in the cost storage 23.

First, the data collector 41 acquires first data (step S101). The age data “70” and a cost “100” required to acquire the age data “70” are received, for example.

Next, the data storage 21 saves the data acquired in step S101 (step S102). As illustrated in FIG. 11A, for example, the age data “70” is written in the CSV file within the data storage 21.

The discontinuation determiner 43 then checks the data storage 21 and examines presence or absence of unacquired data (step S103). The processing returns to step S101 in this case as the gender data and the like are not yet acquired.

The cost calculator 42 calculates the invested cost that is already invested in the processing performed by the data collector 41 and updates the invested cost stored in the cost storage 23 with the calculated value (step S104). As illustrated in FIG. 12A, for example, a record including “100” for the entire process, “100” for the age, “100” for the gender, “100” for the event and “100” for the weather is recorded for the distribution ID “0001”.

Next, the discontinuation determiner 43 acquires the allowable investment cost from the allowable investment cost storage 22 (step S105). The preregistered allowable investment costs “∞, 200, 200, 1000, 1000” (FIG. 9) are acquired in this case, for example.

The discontinuation determiner 43 then compares each of the invested cost for the unacquired data and the invested cost for the entire process with the corresponding allowable investment cost (step S106). The discontinuation determiner 43 transmits the discontinuation signal to the content determiner 44 to discontinue data collection when the invested cost for the entire process exceeds the corresponding allowable investment cost or when the invested cost for all the unacquired data exceeds the allowable investment cost (step S107). Otherwise, the data collector 41 continues the data collection, and the processing returns to step S104.

None of the invested costs “100” (FIG. 12A) exceeds the allowable investment cost in this case, so that the processing returns to step S104 to continue the data collection.

The information processing apparatus 1 then repeats the data collection and update of the invested cost in the same manner until step S107 is executed. Next, an overview of the whole processing will be described. The invested cost for each of the entire process and each data will be hereinafter expressed as “an invested cost for the entire process, an invested cost for the age data, an invested cost for the gender data, an invested cost for the event data, and an invested cost for the weather data”.

When the gender data “male” is acquired 400 milliseconds after the membership card is read by the car reader (step S101), the gender data “male” is recorded in the data storage 21 as illustrated in FIG. 11B since the invested cost for the gender data exceeds the allowable investment cost therefor but the processing continues (step S102). The invested costs are updated to “400, 100, 400, 400, 400” as illustrated in FIG. 12B (step S104).

Next, in step S106, the discontinuation determiner 43 compares the invested cost at this point with the corresponding allowable investment cost illustrated in FIG. 9, and returns the processing to step S104 to continue data collection since the invested costs for the entire process as well as the unacquired event data and weather data do not exceed the corresponding allowable investment costs.

When the event data “Christmas” is acquired 900 milliseconds after the membership card is read by the card reader (step S101), the data is recorded in the data storage 21 as illustrated in FIG. 11C (step S102). The invested costs are updated to “900, 100, 400, 900, 900” as illustrated in FIG. 12C (step S104).

Next, in step S106, the discontinuation determiner 43 compares the invested cost at this point with the allowable investment cost illustrated in FIG. 9, and returns the processing to step S104 to continue data collection since the invested costs for the entire process and the unacquired weather data do not exceed the allowable investment costs.

When it is 1101 milliseconds after the membership card is read by the card reader, the invested costs are updated to “1001, 100, 400, 900, 1001” as illustrated in FIG. 12D with the acquired data unchanged as illustrated in FIG. 11C (step S104).

Next, in step S106, the discontinuation determiner 43 compares the invested cost at this point with the allowable investment cost illustrated in FIG. 9, and transmits the discontinuation signal to the content determiner 44 to discontinue data collection since the invested cost for the weather data exceeds the allowable investment cost therefor (step S107).

The content determiner 44 selects one of the contents by using the data illustrated in FIG. 11C that is acquired at that point (step S108). In the present embodiment, for example, the correspondence between the data used in determination and the content corresponding to the data is determined in advance, so that the content determiner 44 may execute rule based processing that selects the content on the basis of the correspondence.

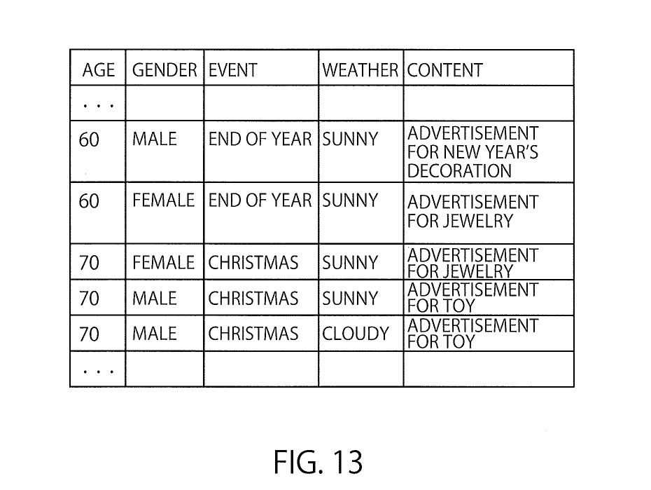

An example of the content selection processing will now be described with reference to FIG. 13. FIG. 13 is a table illustrating an example of the correspondence between a combination of data and a content held by the content determiner 44. The content determiner 44 holds in advance the correspondence between the combination of data and the content for all combinations of data, as illustrated in FIG. 13.

The content determiner 44 randomly determines one of the contents satisfying the combination of data that is already acquired at the timing when the discontinuation signal is received. Note that the correspondence between the combination of data and the content may be updated while the information processing apparatus 1 is in operation. Besides the rule based processing, another recommendation technique such as content based processing or collaborative filtering may be used to achieve the similar object as well. The recommendation technique in this case refers to a technique that specifies a product to be recommended to a specific target of distribution.

Next, the content outputter 45 distributes the content determined in step S108 (step S109).

The discontinuation determiner 43 then replaces the cost, among the latest costs recorded in the cost storage 23, that is not used in content distribution with a blank (step S110).

Through the aforementioned processes, in the present embodiment, the content is determined and distributed 1001 milliseconds after the membership card of the shopper being the target of distribution is read by the card reader. When the content is determined after acquiring all data, in which case 10100 milliseconds are required for the weather data to be acquired in the present embodiment, it is highly likely that the advertising content does not reach the shopper at a timing after acquiring all the data. Accordingly, the present embodiment can reduce the possibility that the content does not reach the target of distribution by determining the content within the limitation on the cost.

The data collector 41 of the information processing apparatus 1 according to the first embodiment collects the plurality of pieces of data, as described above. The discontinuation determiner 43 compares, for each data or the whole processing of collecting the data, the invested cost that is already invested for the data collection with the allowable investment cost that is the upper limit of the cost allowed to be invested for the data collection and, according to the comparison result, determines to discontinue the data collection. When the discontinuation determiner 43 determines to discontinue the data collection, the content determiner 44 uses the data collected by the data collector 41 up to a point when the discontinuation is determined and determines information relevant to a content to be distributed.

As a result, according to the present embodiment, the cost effectiveness in the content distribution can be increased by avoiding a situation where the content is determined after acquiring all the data with excessive cost investment or a situation where the content is determined while the cost is invested too little to contain useful data.

### Second Embodiment

A second embodiment will now be described. The allowable investment cost is preset in the first embodiment. In the second embodiment, on the other hand, an allowable investment cost is determined by using an invested cost that is already invested to collect data.

A hardware configuration of an information processing apparatus 1 of the second embodiment will not be described as it is similar to the hardware configuration of the information processing apparatus 1 of the first embodiment.

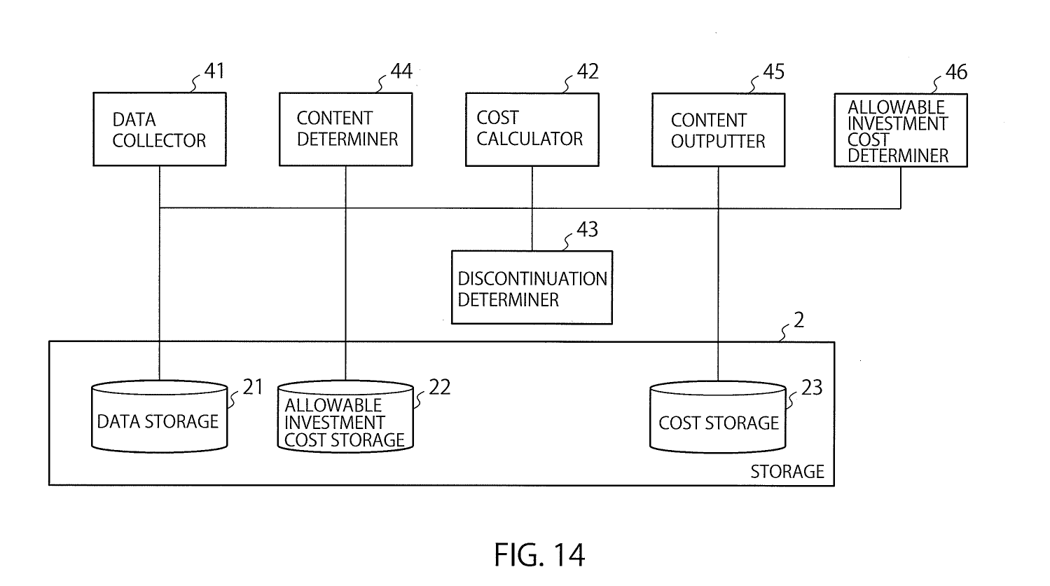

FIG. 14 is a functional block diagram of the information processing apparatus 1 according to the second embodiment. An element common to the one illustrated in FIG. 7 will be assigned the same reference numeral and will not be described in detail. The information processing apparatus 1 of the second embodiment has a configuration where an allowable investment cost determiner 46 is added to the configuration of the information processing apparatus 1 of the first embodiment.

The allowable investment cost determiner 46 determines the allowable investment cost by using the invested cost that is already invested to collect data. The allowable investment cost determiner 46 determines the allowable investment cost from cost data pertaining to data recorded in a cost storage 23 and acquired up to that point (hereinafter referred to as acquired data), and records the cost into an allowable investment cost storage 22, for example. Specifically, for example, the allowable investment cost determiner 46 determines as the allowable investment cost a value obtained by adding a specified extra cost to the highest investment cost among the acquired data. The extra cost is a fixed value given in advance, for example. Here, as an example, the allowable investment cost determiner 46 adds the extra cost of 300 milliseconds equally to an invested cost for an entire process and an invested cost for each unacquired data.

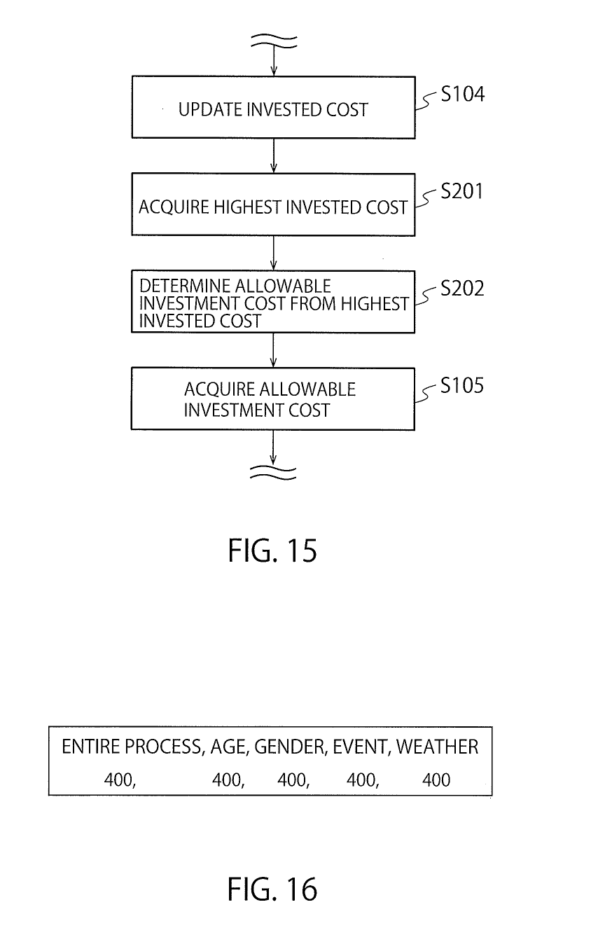

Next, a flow of processing performed in the second embodiment will be described with reference to FIG. 15. FIG. 15 is a flowchart illustrating an example of a part of the flow of processing performed according to the second embodiment. The information processing apparatus 1 of the second embodiment performs processing in FIG. 15 that is the replacement of the processing performed in steps S104 and S105 of the first embodiment illustrated in FIG. 8. The flow of the processing will now be described by using specific data as an example. Here, FIG. 15 and a range related thereto will be described while omitting description of the flow of overall processing that is the same as that of the first embodiment.

The allowable investment cost determiner 46 compares invested costs of the plurality of acquired data and acquires the highest invested cost among the invested costs (step S201). Right after acquiring age data “70” that is acquired first, for example, the age data is the only acquired data in the present embodiment while the invested costs all equal 100 as illustrated in FIG. 12A, whereby the highest investment cost 100 is acquired.

The allowable investment cost determiner 46 determines, as the allowable investment cost, a value obtained by adding the extra cost of 300 milliseconds to the cost acquired in step S201, and records the cost into the allowable investment cost storage 22 (step S202). When the cost acquired in step S201 is 100 milliseconds, for example, the allowable investment cost determiner 46 determines 400 milliseconds to be the allowable investment cost for the entire process and each data as illustrated in FIG. 16, and records these values into the allowable investment cost storage 22. FIG. 16 is a table illustrating an example of each allowable investment cost recorded in the allowable investment cost storage 22.

The information processing apparatus 1 then repeats the data acquisition and update of the invested cost in the same manner until step S107 is executed. Now, an overview of the overall processing will be described briefly.

When gender data “male” is acquired 400 milliseconds after a membership card is read by a car reader (step S101), the acquired gender data “male” is recorded in a data storage 21 as illustrated in FIG. 11B since the invested cost for the gender data exceeds the allowable investment cost therefor but the processing continues (step S102). The invested costs are updated to “400, 100, 400, 400, 400” as illustrated in FIG. 12B (step S104). The allowable investment cost determiner 46 then determines a value of 700 milliseconds, obtained by adding the extra cost of 300 milliseconds to the maximum invested cost of 400 milliseconds, to be the allowable investment cost for the entire process and each data, and records the costs into the allowable investment cost storage 22.

Next, in step S106, a discontinuation determiner 43 compares the invested cost at this point with the corresponding allowable investment cost, and returns the processing to step S104 to continue data collection since the invested costs for the entire process and the unacquired event data and weather data do not exceed the allowable investment costs.

When it is 701 milliseconds after the membership card is read by the card reader, the invested costs are updated to “701, 100, 400, 701, 701” with the acquired data unchanged as illustrated in FIG. 11B (step S104).

Next, in step S106, the discontinuation determiner 43 compares the invested cost at this point with the corresponding allowable investment cost, and discontinues data collection to proceed to step S107 since the invested costs “701” for the entire process as well as the unacquired event data and weather data exceed the corresponding allowable investment costs “700”.

Through the aforementioned processes, in the present embodiment, the content is determined and distributed 701 milliseconds after the membership card of a shopper being a target of distribution is read by the card reader. As described above, a small cost is added to the cost of the data that is currently acquired to only acquire data acquirable within that range. As a result, it can be adapted to not acquire data requiring a large additional cost.

According to the second embodiment, the allowable investment cost determiner 46 determines the allowable investment cost by using the invested cost invested by a data collector 41 to collect data up to the point the allowable investment cost is determined. One can therefore expect the effect of increased cost effectiveness in the long run compared to the first embodiment by changing the allowable investment cost according to the change in the invested cost. This is particularly effective when a data acquisition cost is drastically increased such as when network disconnection causes redesigning of a communication path.

### Third Embodiment

A third embodiment will now be described. In the second embodiment, the allowable investment cost determiner 46 determines the allowable investment cost by using the invested cost invested by the data collector 41 to collect data up to the point the allowable investment cost is determined. In the third embodiment, on the other hand, an allowable investment cost determiner 46 determines an allowable investment cost by using a past acquisition cost that is a cost required for data acquisition in past content distribution.

A hardware configuration of an information processing apparatus 1 of the third embodiment will not be described as it is similar to the hardware configuration of the information processing apparatus 1 of the first embodiment. Moreover, a functional block diagram of the information processing apparatus 1 of the third embodiment will not be described as it is similar to the functional block diagram of the information processing apparatus 1 of the second embodiment.

The allowable investment cost determiner 46 of the third embodiment determines the allowable investment cost in a manner similar to that of the allowable investment cost determiner 46 of the second embodiment but differently therefrom in terms of the following. That is, the allowable investment cost determiner 46 of the third embodiment determines the allowable investment cost by using the past acquisition cost that is the cost required for data acquisition in past content distribution. The allowable investment cost determiner 46 determines the allowable investment cost for each data type. The allowable investment cost determiner 46 determines the allowable investment cost from the past acquisition cost recorded in a cost storage 23, and records the cost into an allowable investment cost storage 22, for example. Specifically, for example, the allowable investment cost determiner 46 acquires the cost saved in the cost storage 23 for each data type, calculates a median of the past acquisition cost for each data type, and determines the median of each data type acquired to be the allowable investment cost of the corresponding data.

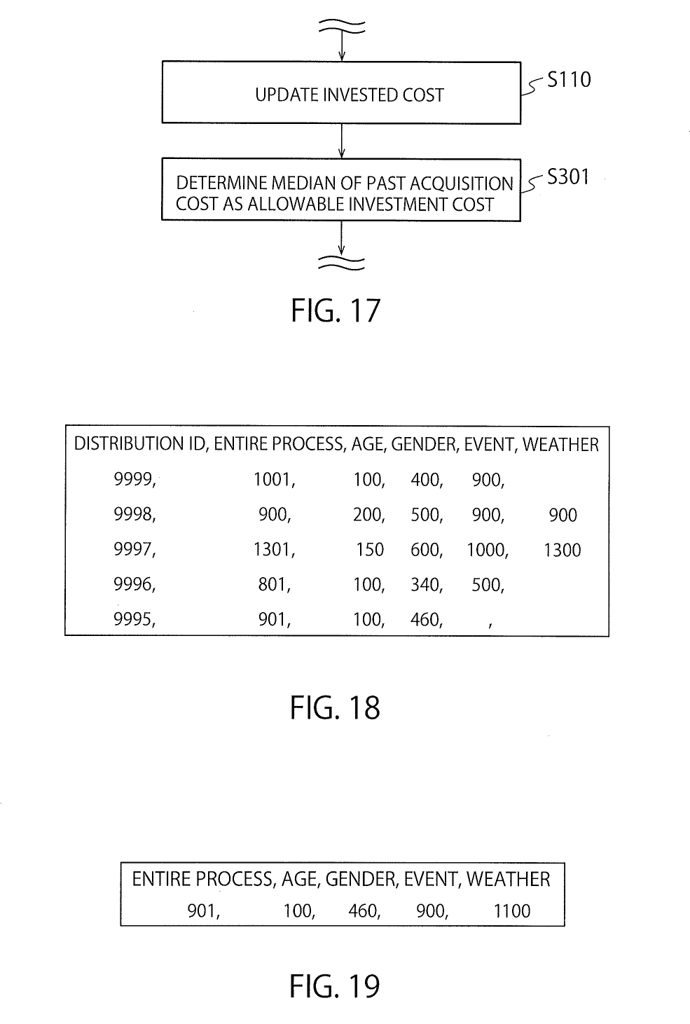

Next, a flow of processing performed in the third embodiment will be described with reference to FIG. 17. FIG. 17 is a flowchart illustrating an example of a part of the flow of processing performed according to the third embodiment. The information processing apparatus 1 of the third embodiment performs processing in FIG. 17 that is the replacement of the processing performed in step S110 onward of the first embodiment illustrated in FIG. 8. The flow of the processing will now be described by using specific data as an example. Here, FIG. 17 and a range related thereto will be described while omitting description of the flow of overall processing that is the same as that of the first embodiment.

Description will be provided assuming that data of the past acquisition cost as illustrated in FIG. 18 is recorded in the cost storage 23 in past content distribution. FIG. 18 is a table illustrating an example of the data of the past acquisition cost required in the past content distribution, the data being stored in the cost storage 23. FIG. 18 illustrates data including a set of a distribution ID, an entire process, an age, a gender, an event, and weather for the past content distribution.

The allowable investment cost determiner 46 acquires the past acquisition cost stored in the cost storage 23, calculates a median for each of the entire process and each data, and records these medians as the allowable investment costs into the allowable investment cost storage 22 (step S301). When a plurality of pieces of data is present, the allowable investment cost determiner 46 determines the allowable investment cost to be equal to an average of two values near the median. When there is no available data, the allowable investment cost determiner 46 determines the allowable investment cost to be zero.

The allowable investment cost illustrated in FIG. 19 is stored in the allowable investment cost storage 22 for the cost data illustrated in FIG. 18, for example. FIG. 19 is a table illustrating an example of the allowable investment cost stored in the allowable investment cost storage 22. The median of the past acquisition cost for the entire process illustrated in FIG. 18 equals 901, whereby 901 is recorded as the allowable investment cost for the entire process as illustrated in FIG. 19.

Specifically, the median of the past acquisition cost for the age illustrated in FIG. 18 equals 100, whereby 100 is recorded as the allowable investment cost for the age as illustrated in FIG. 19. The median of the past acquisition cost for the gender illustrated in FIG. 18 equals 460, whereby 460 is recorded as the allowable investment cost for the gender as illustrated in FIG. 19. Two values near the median of the past acquisition cost for the event illustrated in FIG. 18 both equal 900, whereby 900 is recorded as the allowable investment cost for the event as illustrated in FIG. 19. Two values near the median of the past acquisition cost for the weather illustrated in FIG. 18 equal 900 and 1300, whereby 1100 that is the average of 900 and 1300 is recorded as the allowable investment cost for the weather as illustrated in FIG. 19.

Upon determination of this allowable investment cost, data is received once again in a manner similar to that of the first embodiment. Now, an overview of processing performed up to step S107 will be described briefly.

When age data “70” is acquired 100 milliseconds after a membership card is read by a card reader (step S101), the data is recorded in a data storage 21 as first acquired data. The invested costs are updated to “100, 100, 100, 100, 100” as illustrated in FIG. 12A (step S104).

Next, in step S106, a discontinuation determiner 43 compares the invested cost at this point with the corresponding allowable investment cost, and returns the processing to step S104 to continue to wait for data acquisition since the invested costs for the entire process as well as the unacquired gender data, event data and weather data do not exceed the corresponding allowable investment costs illustrated in FIG. 19.

When gender data “male” is acquired 400 milliseconds after the membership card is read by the car reader (step S101), the gender data “male” is recorded in the data storage 21 as illustrated in FIG. 11B since the invested cost for the gender data exceeds the allowable investment cost therefor but the processing continues (step S102). The invested costs are updated to “400, 100, 400, 400, 400” (step S104).

Next, in step S106, the discontinuation determiner 43 compares the invested cost at this point with the corresponding allowable investment cost, and returns the processing to step S104 to continue to wait for data acquisition since the invested costs for the entire process and the unacquired event data and weather data do not exceed the corresponding allowable investment costs illustrated in FIG. 19.

When event data “Christmas” is acquired 900 milliseconds after the membership card is read (step S101), the event data “Christmas” is recorded in the data storage 21 (step S102). The invested costs are updated to “900, 100, 400, 900, 900” (step S104).

Next, in step S106, the discontinuation determiner 43 compares the invested cost at this point with the corresponding allowable investment cost, and returns the processing to step S104 to continue to wait for data acquisition since the invested costs for the entire process and the unacquired weather data do not exceed the corresponding allowable investment costs illustrated in FIG. 19.

When it is 902 milliseconds after the membership card is read, the invested costs are updated to “902, 100, 400, 900, 902” with the acquired data unchanged as illustrated in FIG. 11C (step S104).

Next, in step S106, the discontinuation determiner 43 compares the invested cost at this point with the corresponding allowable investment cost, and transmits a discontinuation signal to a content determiner 44 to discontinue data acquisition since the invested cost for the entire process exceeds the corresponding allowable investment cost illustrated in FIG. 19 (step S107).

Through the aforementioned processes, in the present embodiment, the content is determined and distributed 902 milliseconds after the membership card of a shopper being a target of distribution is read by the card reader.

The allowable investment cost determiner 46 of the third embodiment determines the allowable investment cost by using the past acquisition cost that is the cost required for data acquisition in the past content distribution. The discontinuation determiner 43 discontinues the data collection when the invested cost exceeds the allowable investment cost determined as described above. As a result, the content distribution having the same effect as the first embodiment can be executed with less investment cost than the first embodiment which does not take past into account. This is particularly effective when data acquisition trend is significantly different from the assumption made in advance or changes according to time, for example.

### Fourth Embodiment

A fourth embodiment will now be described. The allowable investment cost determiner 46 of the third embodiment determines the allowable investment cost by using the past acquisition cost that is the cost required for data acquisition in past content distribution. In the fourth embodiment, on the other hand, an allowable investment cost is determined by using acquired data that is a piece of data already acquired, past acquired data acquired by a data collector 41 to execute content distribution in the past, and a past acquisition cost that is a cost required for acquiring the past acquired data.

A hardware configuration of an information processing apparatus 1 of the fourth embodiment will not be described as it is similar to the hardware configuration of the information processing apparatus 1 of the first embodiment. Moreover, a functional block diagram of the information processing apparatus 1 of the fourth embodiment will not be described as it is similar to the functional block diagram of the information processing apparatus 1 of the second embodiment.

An allowable investment cost determiner 46 of the fourth embodiment determines the allowable investment cost in a manner similar to that of the allowable investment cost determiner 46 of the second embodiment but differently therefrom in terms of the following. The allowable investment cost determiner 46 determines the allowable investment cost by using the acquired data that is a piece of data already acquired, the past acquired data acquired by the data collector 41 to execute content distribution in the past, and the past acquisition cost that is the cost required for acquiring the past acquired data.

More specifically, the allowable investment cost determiner 46 determines the allowable investment cost from the acquired data and past acquired data recorded in a data storage 21 as well as the past acquisition cost recorded in a cost storage 23. The allowable investment cost determiner 46 then records the determined allowable investment cost into an allowable investment cost storage 22.

The allowable investment cost determiner 46 identifies past content distribution including a piece of data having the same type and value as the acquired data in the data storage 21, for example. Then, for each data type, the allowable investment cost determiner 46 acquires from the cost storage 23 the past acquisition cost required for data acquisition in the identified past content distribution, calculates a median of the past acquisition cost for each data type, and determines the allowable investment cost for the corresponding data type to be the calculated median.

When there is no past content distribution satisfying the aforementioned condition, the cost of all content distribution recorded is used. That is, the processing identical to that of the third embodiment is performed.

The allowable investment cost determiner 46 determines the allowable investment cost by identifying the past content distribution including the data that has the same type and value as the acquired data and using the past acquisition cost of the past content distribution identified.

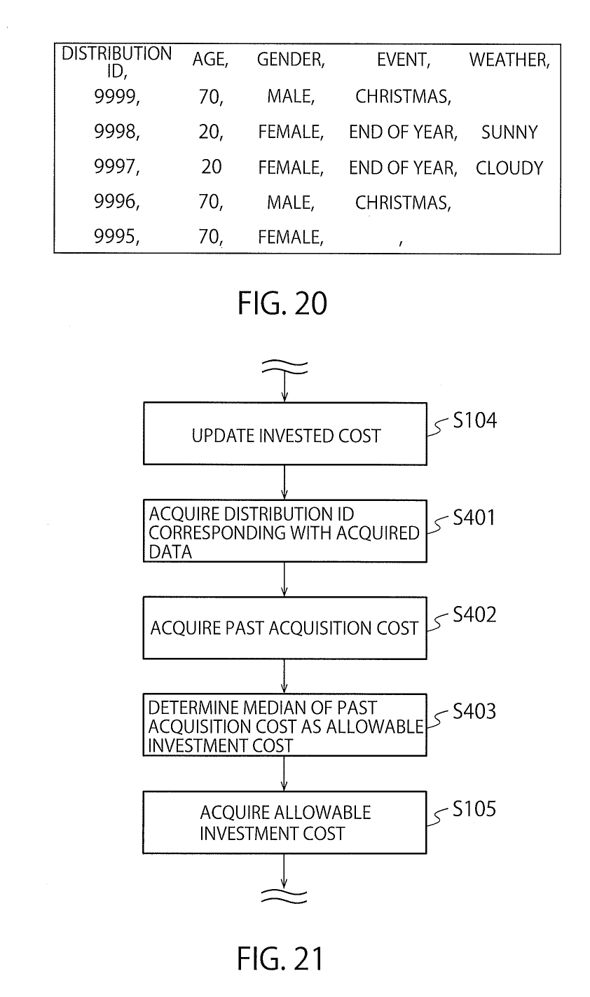

Description will be provided assuming that data as illustrated in FIG. 20 is recorded in the data storage 21 in the past content distribution, for example. FIG. 20 is a table illustrating an example of the data recorded in the data storage 21 in the past content distribution.

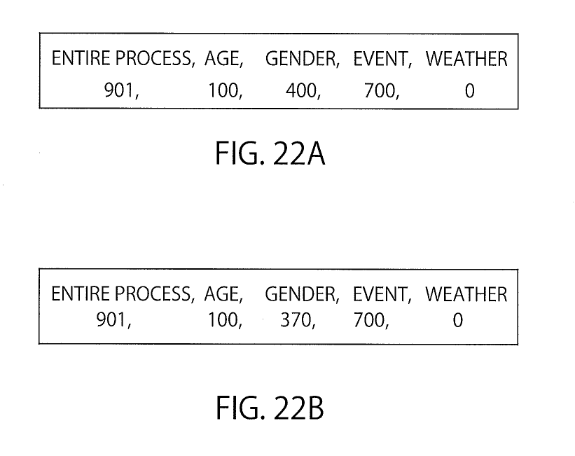

A flow of processing performed in the fourth embodiment will be described with reference to FIGS. 21 and 22. FIG. 21 is a flowchart illustrating an example of a part of the flow of processing performed according to the fourth embodiment.

The information processing apparatus 1 of the fourth embodiment performs processing in FIG. 21 that is the replacement of the processing performed in steps S104 and S105 of the first embodiment illustrated in FIG. 8. The flow of the processing will now be described by using specific data as an example. Here, FIG. 21 and a range related thereto will be described while omitting description of the flow of overall processing that is the same as that of the first embodiment. FIGS. 22A and 22B are tables each illustrating an example of the allowable investment cost according to the fourth embodiment.

When age data “70” is acquired 100 milliseconds after a membership card is read by a card reader (step S101), the age data “70” is recorded in the data storage 21 as first acquired data, as illustrated in FIG. 11A (step S102). The invested costs are updated to “100, 100, 100, 100, 100” as illustrated in FIG. 12A (step S104).

The allowable investment cost determiner 46 at this time searches the data storage 21 for past content distribution with the age data “70”, thereby acquiring distribution IDs “9999”, “9996”, and “9995” (step S401).

Next, the allowable investment cost determiner 46 acquires from the cost storage 23 a past invested cost with the distribution ID acquired in step S401 (step S402). As a result, a past acquisition cost corresponding to each of the distribution IDs “9999”, “9996”, and “9995” in FIG. 18 can be acquired, for example.

The allowable investment cost determiner 46 then calculates, for each data type, a median of the data acquired in step S402 and determines the median to be the allowable investment cost of the corresponding data type (step S403). The allowable investment costs therefore equal “901, 100, 400, 700, 0” as illustrated in FIG. 22A, for example.

Next, in step S106, a discontinuation determiner 43 compares the invested cost with the corresponding allowable investment cost illustrated in FIG. 22A, and returns the processing to step S104 to continue data collection since the invested costs for the entire process as well as the unacquired data (gender data, event data and weather data) do not exceed the corresponding allowable investment costs.

When gender data “male” is acquired 400 milliseconds after the membership card is read by the card reader (step S101), the gender data “male” is recorded in the data storage 21 as illustrated in FIG. 11B (step S102). The invested costs are updated to “400, 100, 400, 400, 400”.

At this time, in step S401, the allowable investment cost determiner 46 searches the data storage 21 for a distribution ID identifying past content distribution with the age data “70” and the gender data “male”, thereby acquiring the distribution IDs “9999” and “9996”.

Next, in step S402, the allowable investment cost determiner 46 acquires a past acquisition cost with the distribution ID from the cost storage 23. As a result, a past acquisition cost corresponding to each of the distribution IDs “9999” and “9996” in FIG. 18 can be acquired, for example.

Next, the allowable investment cost determiner 46 in step S403 calculates, for each data type, a median of the data acquired in step S402 and determines the median as the allowable investment cost of the corresponding data type. The allowable investment costs therefore equal “901, 100, 370, 700, 0” as illustrated in FIG. 22B, for example.

Next, in step S106, the discontinuation determiner 43 compares the invested cost at this point with the corresponding allowable investment cost, and returns the processing in step S104 to continue data collection since the invested costs for the entire process and the unacquired event data do not exceed the corresponding allowable investment costs illustrated in FIG. 22B.

When it is 701 milliseconds after the membership card is read by the card reader, the invested costs are updated to “701, 100, 400, 701, 701” with the acquired data unchanged as illustrated in FIG. 11B (step S104).

Next, in step S106, the discontinuation determiner 43 compares the invested cost at this point with the corresponding allowable investment cost illustrated in FIG. 22B, and transmits a discontinuation signal to a content determiner 44 to discontinue data collection since the invested cost “701” for the unacquired event data exceeds the corresponding allowable investment cost “700” illustrated in FIG. 22B (step S107).

Through the aforementioned processes, in the present embodiment, the content is determined and distributed 701 milliseconds after the membership card of a shopper is read by the card reader.

In the fourth embodiment, the allowable investment cost determiner 46 determines the allowable investment cost by identifying the past content distribution including the data that has the same type and value as the acquired data and using the past acquisition cost of the past content distribution identified.

As a result, the acquired data is used to be able to refer to the past acquisition cost by narrowing down to the past content distribution with a data acquisition state closer to a current data acquisition state. One can therefore expect the effect of increased cost effectiveness in the long run compared to the third embodiment when the data acquisition cost has a fixed pattern.

### Fifth Embodiment

A fifth embodiment will now be described. In the fourth embodiment, the allowable investment cost determiner 46 determines the allowable investment cost by identifying the past content distribution including the data that has the same type and value as the acquired data and using the past acquisition cost of the past content distribution identified. On the other hand, an allowable investment cost determiner 46 in the fifth embodiment determines an allowable investment cost by identifying past content distribution to be used to determine the allowable investment cost on the basis of a pair of a past acquisition cost and a value of effect information on the effect of past content distribution, and using a past acquisition cost in the past content distribution identified.

A hardware configuration of an information processing apparatus 1 of the fifth embodiment will not be described as it is similar to the hardware configuration of the information processing apparatus 1 of the first embodiment.

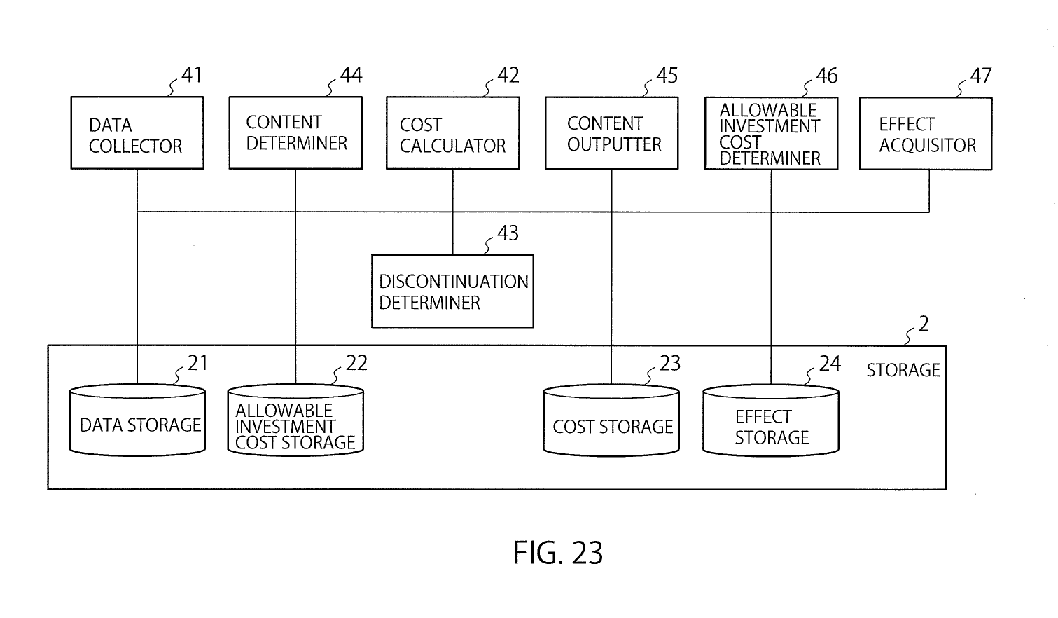

FIG. 23 is a functional block diagram of the information processing apparatus 1 according to the fifth embodiment. An element common to the one illustrated in FIG. 7 will be assigned the same reference numeral and will not be described in detail. The information processing apparatus 1 of the fifth embodiment has a configuration where an allowable investment cost determiner 46 and an effect acquisitor 47 as well as an effect storage 24 in the storage 2 are added to the configuration of the information processing apparatus 1 of the first embodiment.

The effect acquisitor 47 acquires the effect information on the effect of past content distribution.

The effect acquisitor 47 for example receives the effect information on the effect of content distribution from outside the information processing apparatus 1 and records the effect information in the effect storage 24.

The information may be received from a digital signage terminal, for example, when the digital signage terminal at a content distribution destination includes an input device which accepts an evaluation from a target of distribution.

Specifically, for example, the effect acquisitor 47 may receive the count of a “like” button pressed as the effect information as described earlier, the button being provided on the digital signage terminal.

Moreover, when a content is intended to promote purchase of a specific product, for example, information indicating whether or not the specific product is purchased or indicating sales thereof may be received as the effect information from a point of sales information management system.

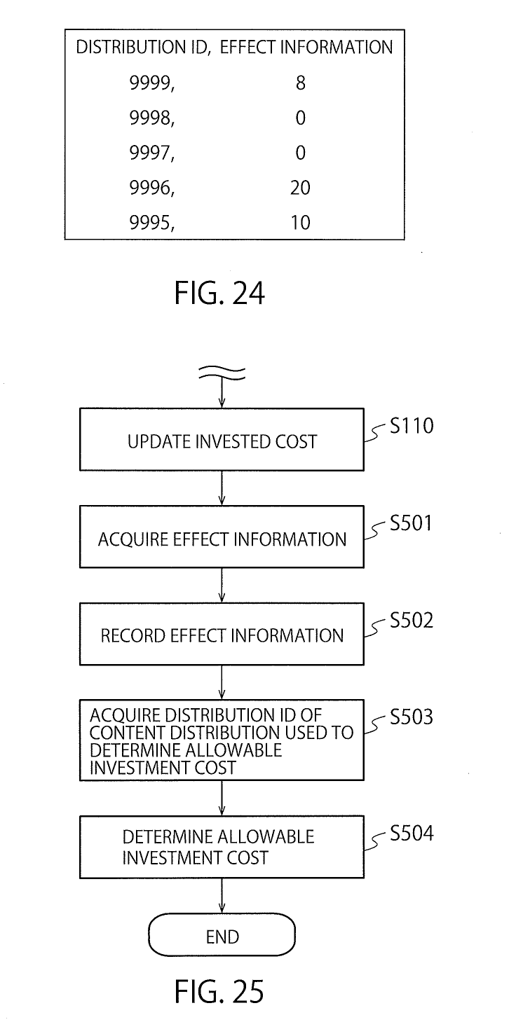

The effect storage 24 holds the effect information acquired by the effect acquisitor 47. The effect storage 24 may store the effect information in an electronic file, a database, or in another form. The effect storage 24 saves a pair of a distribution ID identifying content distribution and the effect information in a CSV file format, for example. FIG. 24 is a table illustrating an example of data stored in the effect storage 24. The present embodiment will be described assuming that the pair of the distribution ID and the effect information are recorded as illustrated in FIG. 24. Here, as an example, a value of the effect information equals the count of the “like” button pressed, where the effect of content distribution on the target of distribution is higher as the value of the effect information is larger.

The allowable investment cost determiner 46 determines the allowable investment cost by using the past acquisition cost that is a cost required for a data collector 41 to acquire data in past content distribution and the effect information on the effect of the past content distribution. More specifically, the allowable investment cost determiner 46 determines the allowable investment cost from an investment cost in the past content distribution recorded in a cost storage 23 and the effect information recorded in the effect storage 24.

The allowable investment cost determiner 46 for example assumes that a value of cost effectiveness of an entire process follows a normal distribution and collects a past acquisition cost in past content distribution having the cost effectiveness that falls within the range corresponding to an average or higher in this distribution. The cost effectiveness of the entire process is a value obtained by dividing the value of the effect information by a cost of the entire process. Similar to the third embodiment, the allowable investment cost determiner 46 then determines a median of the collected past acquisition cost as the corresponding allowable investment cost for the entire process and each data.

The allowable investment cost determiner 46 determines the allowable investment cost by collecting the past acquisition cost in the past content distribution used to determine the allowable investment cost on the basis of the pair of the past acquisition cost and the value of effect information, and using the past acquisition cost collected. The allowable investment cost determiner 46 then records the determined allowable investment cost into an allowable investment cost storage 22.

Next, a flow of processing performed in the fifth embodiment will be described with reference to FIG. 25. FIG. 25 is a flowchart illustrating an example of a part of the flow of processing performed according to the fifth embodiment. The information processing apparatus 1 of the fifth embodiment performs processing in FIG. 25 that is the replacement of the processing performed in step S110 onward of the first embodiment illustrated in FIG. 8. The flow of the processing will now be described by using specific data as an example. Here, FIG. 25 and a range related thereto will be described while omitting description of the flow of overall processing that is the same as that of the first embodiment.

Following step S110, the effect acquisitor 47 acquires the effect information on the effect of past content distribution (step S501).

Next, the effect storage 24 records the effect information acquired in step S501 (step S502). The effect storage 24 records the pair of the distribution ID and the effect information in the form illustrated in FIG. 24 every time the effect information is acquired, for example.

The allowable investment cost determiner 46 then acquires past content distribution to be used to determine the allowable investment cost by using the cost recorded in the cost storage 23 and the effect information recorded in the effect storage 24 (step S503).

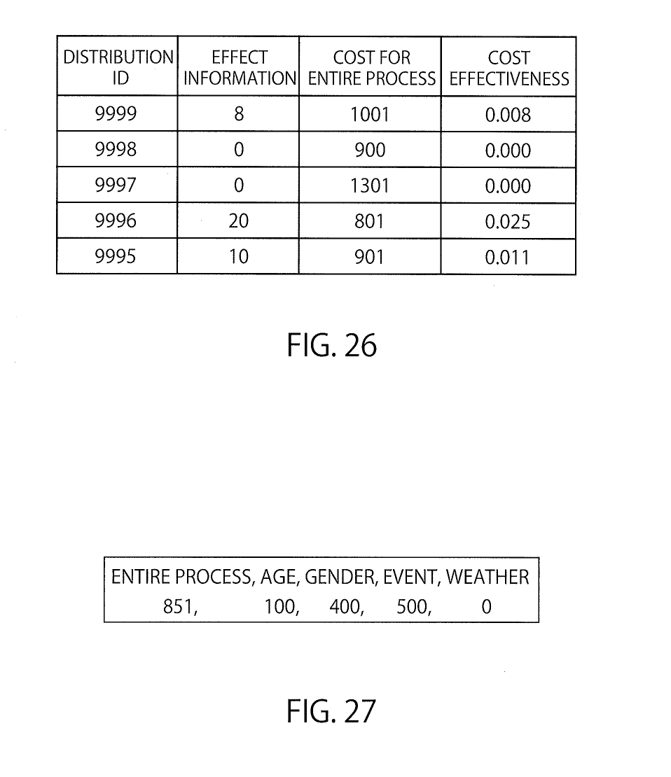

As a specific example, the allowable investment cost determiner 46 calculates as the cost effectiveness a value obtained by dividing the past acquisition cost of the entire process illustrated in FIG. 18 by the value of the effect information illustrated in FIG. 24, for each distribution ID. As a result, the cost effectiveness can be acquired for each distribution ID as illustrated in FIG. 26. FIG. 26 is a table illustrating an example of data representing the cost effectiveness. FIG. 26 illustrates a set of the distribution ID, effect information, cost of the entire process, and cost effectiveness.

The allowable investment cost determiner 46 thereafter calculates an average of the cost effectiveness, for example. The average of the cost effectiveness 0.009 (=(0.008+0.000+0.000+0.025+0.011)/5) can thus be acquired. The allowable investment cost determiner 46 compares the average of the cost effectiveness 0.009 with each cost effectiveness illustrated in FIG. 26 and acquires distribution IDs “9996” and “9995” of content distribution having the cost effectiveness equal to the average or higher. As a result, the distribution ID of the content distribution to be used to determine the allowable investment cost can be acquired.

Next, the allowable investment cost determiner 46 determines the allowable investment cost by using the past acquisition cost of the content distribution identified by the distribution ID that is acquired in step S503 (step S504). FIG. 27 is a table illustrating an example of the allowable investment cost determined in the fifth embodiment.

When a method similar to that of the third embodiment is used, for example, the allowable investment costs “851, 100, 400, 500, 0” as illustrated in FIG. 27 are calculated from the invested costs of the distribution IDs “9996” and “9995” illustrated in FIG. 18.

Next, the flow of processing will be described together with the flow of data collection.

When age data “70” is acquired 100 milliseconds after a membership card is read by a card reader (step S101), the age data “70” is recorded in the data storage 21 as first acquired data, as illustrated in FIG. 11A (step S102). The invested costs are updated to “100, 100, 100, 100, 100” as illustrated in FIG. 12A (step S104).

Next, in step S106, a discontinuation determiner 43 compares the invested cost at this point with the corresponding allowable investment cost, and returns the processing to step S104 to continue to wait for data acquisition since the invested costs for the entire process and the unacquired gender data and event data do not exceed the corresponding allowable investment costs illustrated in FIG. 27.

When gender data “male” is acquired 400 milliseconds after the membership card is read by the card reader (step S101), the gender data “male” is recorded in the data storage 21 as illustrated in FIG. 11B (step S102). The invested costs are updated to “400, 100, 400, 400, 400” as illustrated in FIG. 12B (step S104).

Next, in step S106, the discontinuation determiner 43 compares the invested cost at this point with the corresponding allowable investment cost. The discontinuation determiner 43 returns the processing to step S104 to continue data collection since the invested costs for the entire process and the unacquired event data at this point do not exceed the corresponding allowable investment costs illustrated in FIG. 27.

When it is 501 milliseconds after the membership card is read by the card reader, the invested costs are updated to “501, 100, 400, 501, 501” with the acquired data unchanged as illustrated in FIG. 11B (step S104).

Next, in step S106, the discontinuation determiner 43 compares the invested cost at this point with the allowable investment cost illustrated in FIG. 27, and transmits a discontinuation signal to a content determiner 44 to discontinue the data collection since the invested costs for both the unacquired event data and weather data exceed the corresponding allowable investment costs (step S107).

Through the aforementioned processes, in the present embodiment, the content is determined and distributed 501 milliseconds after the membership card of a shopper is read by the card reader.

The allowable investment cost determiner 46 in the fifth embodiment determines the allowable investment cost by collecting the past acquisition cost in the past content distribution used to determine the allowable investment cost on the basis of the pair of the past acquisition cost and the value of effect information, and using the past acquisition cost collected.

This allows for the determination of the allowable investment cost closer to the past acquisition cost in favorable past content distribution, whereby one can expect the effect of increased cost effectiveness in the long run compared to the third embodiment. This is particularly effective when there is a fixed correlation between the cost effectiveness and the past acquisition cost of each data.

### Sixth Embodiment

A sixth embodiment will now be described. In the fifth embodiment, the allowable investment cost is determined by collecting the past acquisition cost in the past content distribution used to determine the allowable investment cost on the basis of the pair of the past acquisition cost and the value of effect information, and using the past acquisition cost collected. On the other hand, what is different in the sixth embodiment is that an allowable investment cost determiner 46 narrows down past content distribution used to collect a past acquisition cost to be used in determining an allowable investment cost to the one with past acquired data having the same type and value as acquired data.

A hardware configuration of an information processing apparatus 1 of the sixth embodiment will not be described as it is similar to the hardware configuration of the information processing apparatus 1 of the first embodiment. Moreover, a functional block diagram of the information processing apparatus 1 of the sixth embodiment will not be described as it is similar to the functional block diagram of the information processing apparatus 1 of the fifth embodiment.

An effect acquisitor 47 of the sixth embodiment acquires effect information on the effect of past content distribution, as is the case with the fifth embodiment.

The allowable investment cost determiner 46 of the sixth embodiment determines the allowable investment cost by a method different from the method employed by the allowable investment cost determiner 46 of the fifth embodiment.

The allowable investment cost determiner 46 determines the allowable investment cost by using acquired data that is a piece of data already acquired, past acquired data acquired by a data collector 41 to execute content distribution in the past, a past acquisition cost that is a cost required for acquiring the past acquired data, and a corresponding piece of effect information.

More specifically, the allowable investment cost determiner determines the allowable investment cost from a past acquisition cost in past content distribution recorded in a cost storage 23 and the effect information recorded in an effect storage 24 by using the acquired data and past acquired data recorded in a data storage 21.

The allowable investment cost determiner 46 identifies past content distribution including a piece of data having the same type and value as the acquired data recorded in the data storage 21, for example. The allowable investment cost determiner 46 then acquires from the cost storage 23 the past acquisition cost required for acquiring data in the past content distribution identified, and acquires from the effect storage 24 the effect information on the past content distribution identified.

After that, the allowable investment cost determiner 46 uses the pair of the acquired past acquisition cost and effect information to determine the allowable investment cost in a manner similar to that of the fifth embodiment. Specifically, the allowable investment cost determiner 46 uses the pair of the past acquisition cost and effect information to calculate cost effectiveness of an entire process for each pair, and collects the past acquisition cost in the past content distribution having the cost effectiveness that falls within the range corresponding to an average or higher in a distribution of the acquired cost effectiveness. The cost effectiveness of the entire process is a value obtained by dividing the value of the effect information by a cost of the entire process, as described above. The allowable investment cost determiner 46 then determines a median of the collected past acquisition cost as the corresponding allowable investment cost for the entire process and each data.

The allowable investment cost determiner 46 identifies the past acquired data including the data having the same type and value as the acquired data. The allowable investment cost determiner 46 then collects the past acquisition cost in the past content distribution used to determine the allowable investment cost by using the past acquisition cost in the past content distribution identified and the corresponding effect information. As a result, the allowable investment cost determiner 46 determines the allowable investment cost by using the past acquisition cost collected. The allowable investment cost determiner 46 records the determined allowable investment cost into an allowable investment cost storage 22.

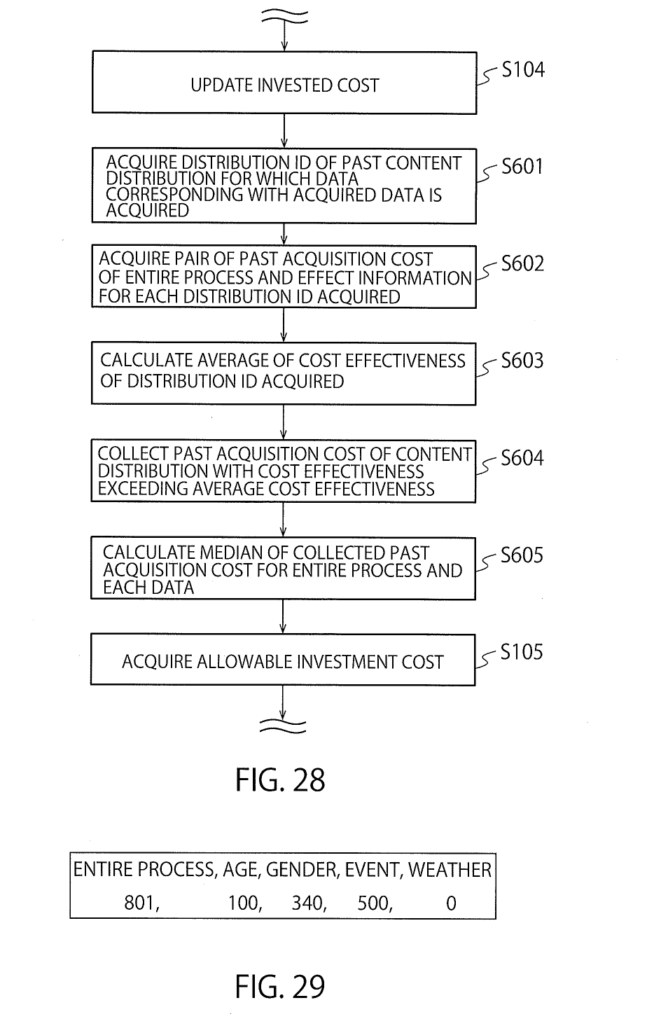

Next, a flow of processing performed in the sixth embodiment will be described with reference to FIG. 28. FIG. 28 is a flowchart illustrating an example of a part of the flow of processing performed according to the sixth embodiment. The information processing apparatus 1 of the sixth embodiment performs processing in FIG. 28 that is the replacement of the processing performed in steps S104 and S105 of the first embodiment illustrated in FIG. 8. The flow of the processing will now be described by using specific data as an example. Here, FIG. 28 and a range related thereto will be described while omitting description of the flow of overall processing that is the same as that of the first embodiment. FIG. 29 is a table illustrating an example of the allowable investment cost according to the sixth embodiment. Next, the flow of processing will be described together with the flow of data acquisition by using FIGS. 28 and 29.

The allowable investment cost determiner 46 acquires a distribution ID of past content distribution for which data corresponding with the acquired data is acquired (step S601).

It is assumed, for example, that age data “70” is acquired 100 milliseconds after a membership card is read by a card reader, and the age data “70” is recorded in the data storage 21 as first acquired data, as illustrated in FIG. 11A. Invested costs are updated to “100, 100, 100, 100, 100” as illustrated in FIG. 12A.

At this time, in step S601, the allowable investment cost determiner 46 searches for a distribution ID identifying past content distribution with the age data “70” in the data storage 21 in which the past acquired data illustrated in FIG. 20 is saved. The allowable investment cost determiner 46 acquires distribution IDs “9999”, “9996”, and “9995” as a result of the search.

Next, for each distribution ID acquired in step S601, the allowable investment cost determiner 46 acquires the pair of the past acquisition cost of the entire process being one of the past acquisition costs and the effect information (step S602). Specifically, for each of the distribution IDs “9999”, “9996”, and “9995”, the allowable investment cost determiner 46 acquires the past acquisition cost of the entire process recorded in the cost storage 23 as illustrated in FIG. 18 as well as the effect information recorded in the effect storage 24 as illustrated in FIG. 24.

Next, the allowable investment cost determiner 46 calculates an average of the cost effectiveness for the distribution ID acquired in step S601 (step S603). Specifically, the allowable investment cost determiner 46 calculates the average of the cost effectiveness by using the pair of the past acquisition cost of the entire process and the effect information acquired in step S602. The average of the cost effectiveness 0.014 (=(0.008+0.025+0.011)/3) can thus be acquired (refer to FIG. 26).

Next, the allowable investment cost determiner 46 collects a past acquisition cost of content distribution that has the cost effectiveness exceeding the average of the cost effectiveness calculated in step S603 (step S604). Here, for example, the distribution with the distribution ID “9996” is the only one that has the cost effectiveness exceeding the average cost effectiveness 0.014, so that the allowable investment cost determiner 46 collects the past acquisition cost for the distribution ID “9996” illustrated in FIG. 18.

Next, the allowable investment cost determiner 46 uses the past acquisition cost collected in step S604 to calculate a median of the collected past acquisition cost for the entire process and each data, and determines the calculated median as the corresponding allowable investment cost (step S605). Here, for example, the allowable investment cost determiner 46 determines the past acquisition cost for the distribution ID “9996” illustrated in FIG. 18 as the allowable investment cost since the past acquisition cost for the distribution ID “9996” is the only past acquisition cost acquired in step S604. The allowable investment costs are thus determined to be “800, 100, 340, 500, 0” as illustrated in FIG. 29.

When it is 341 milliseconds after a membership card is read by a card reader, the invested costs equal “341, 100, 340, 341, 341” with the acquired data unchanged as illustrated in FIG. 11A.

A discontinuation determiner 43 compares the invested cost at this point with the allowable investment cost illustrated in FIG. 29, and transmits a discontinuation signal to a content determiner 44 to discontinue data acquisition (step S107) since the invested costs for both the unacquired event data and weather data exceed the corresponding allowable investment costs (step S106).

Through the aforementioned processes, in the present embodiment, the content is determined and distributed 341 milliseconds after the membership card of a shopper is read by the card reader.

The allowable investment cost determiner 46 in the sixth embodiment determines the allowable investment cost by identifying the past acquired data including the data that has the same type and value as the acquired data, collecting the past acquisition cost in the past content distribution used to determine the allowable investment cost by using the past acquisition cost in the past content distribution identified and the corresponding effect information, and using the past acquisition cost collected.

The past content distribution used to collect the past acquisition cost to be used in determining the allowable investment cost is narrowed down to the past content distribution in which the data corresponding with the acquired data is acquired. One can therefore expect the effect of increased cost effectiveness in the long run compared to the fifth embodiment when the data acquisition cost has a fixed pattern.

### Seventh Embodiment

A seventh embodiment will now be described. The allowable investment cost determiner 46 in the sixth embodiment determines the allowable investment cost by identifying the past acquired data including the data that has the same type and value as the acquired data, collecting the past acquisition cost in the past content distribution used to determine the allowable investment cost by using the past acquisition cost in the past content distribution identified and the corresponding effect information, and using the past acquisition cost collected. On the other hand, in the seventh embodiment, an information processing apparatus 1 determines an expected value of cost effectiveness and uses the determined expected value of cost effectiveness to determine an allowable investment cost.

A hardware configuration of the information processing apparatus 1 of the seventh embodiment will not be described as it is similar to the hardware configuration of the information processing apparatus 1 of the first embodiment.

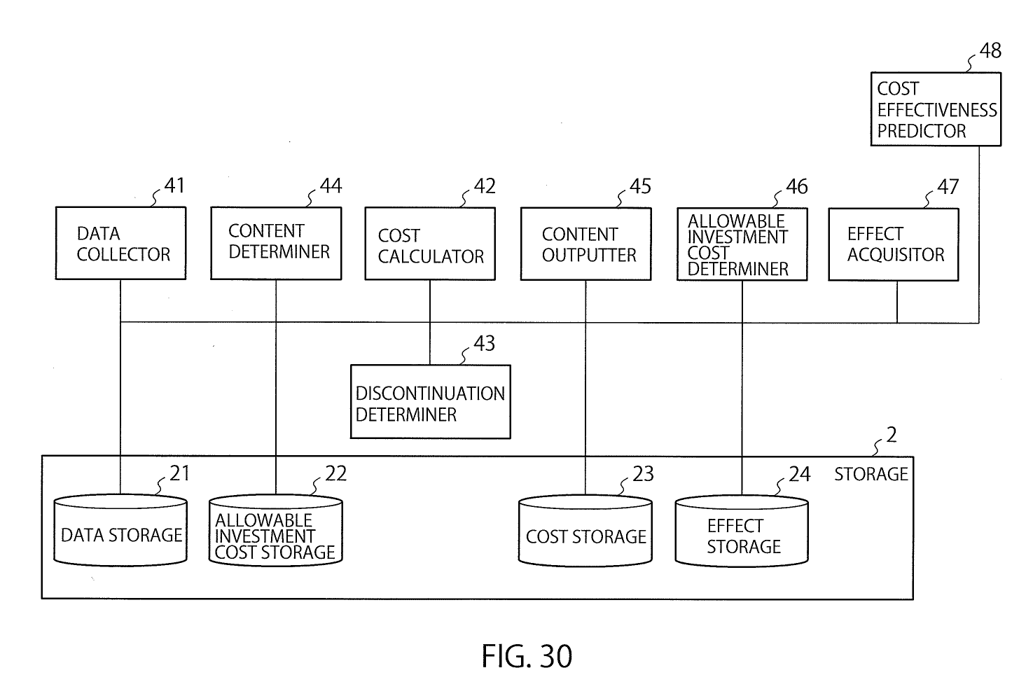

FIG. 30 is a functional block diagram of the information processing apparatus 1 according to the seventh embodiment. An element common to the one illustrated in FIG. 7 will be assigned the same reference numeral and will not be described in detail. The information processing apparatus 1 of the seventh embodiment has a configuration where an allowable investment cost determiner 46, an effect acquisitor 47, and a cost effectiveness predictor 48 as well as an effect storage 24 in a storage 2 are added to the configuration of the information processing apparatus 1 of the first embodiment.

The effect acquisitor 47 acquires effect information on the effect of past content distribution and records the effect information in the effect storage 24, as is the case with the fifth and sixth embodiments.

The cost effectiveness predictor 48 uses acquired data that is a piece of data already acquired, past acquired data acquired by a data collector 41 for past content distribution, a past acquisition cost required to acquire the past acquired data, and the corresponding effect information and, for each predicted data that is to be possibly acquired, determines a predicted cost and an expected value of cost effectiveness when the predicted data is acquired, the predicted cost being an predicted value of a cost required to acquire the predicted data when data identical to the acquired data is acquired.

More specifically, the cost effectiveness predictor 48 determines the expected value of the cost effectiveness from the acquired data and past acquired data recorded in a data storage 21, the past acquisition cost in the past content distribution recorded in a cost storage 23, and the effect information recorded in an effect storage 24.

The cost effectiveness predictor 48 for example checks an update in the data storage 21, compiles the past acquired data and past acquisition cost recorded in the data storage 21 and the cost storage 23 every time new data is acquired, and estimates the predicted data that is to be possibly acquired and the corresponding predicted cost.

While the prediction is performed on the basis of simple tabulation as an example, a known technique such as various regression models and Bayesian inference may be used to perform the prediction.

Then, for each predicted data that is to be possibly acquired, the cost effectiveness predictor 48 calculates an average of the effect information acquired in the past content distribution for which the predicted data is acquired in addition to the acquired data, for example. The cost effectiveness predictor 48 then calculates, as the expected value of the cost effectiveness, a value obtained by dividing the calculated average of the effect information by the predicted cost of the predicted data and multiplying the outcome by a predicted incidence of the predicted data. The predicted incidence is a probability that the predicted data is to be acquired when the data identical to the acquired data is acquired.

The cost effectiveness predictor 48 determines the expected value of the cost effectiveness for each predicted data by using the effect information acquired in the past content distribution for which the predicted data is acquired in addition to the acquired data as well as the predicted cost and the predicted incidence.

The cost effectiveness predictor 48 thereafter records in a storage 2 the calculated expected value of the cost effectiveness in association with the predicted cost

The allowable investment cost determiner 46 determines an allowable investment cost by using the predicted cost and the expected value of the cost effectiveness. The allowable investment cost determiner 46 for example checks an update of the expected value of the cost effectiveness calculated by the cost effectiveness predictor 48, and determines the allowable investment cost by using an updated result every time the update is performed. Specifically, for example, the allowable investment cost determiner 46 compares the expected values of the cost effectiveness every time the cost effectiveness predictor 48 determines the expected value of the cost effectiveness, and determines the allowable investment cost to be a cost associated with the highest expected value of the cost effectiveness.

The allowable investment cost determiner 46 compares the expected values of the cost effectiveness and determines the cost according to the comparison result as the allowable investment cost, as described above.

The allowable investment cost determiner 46 records the determined allowable investment cost into an allowable investment cost storage 22.

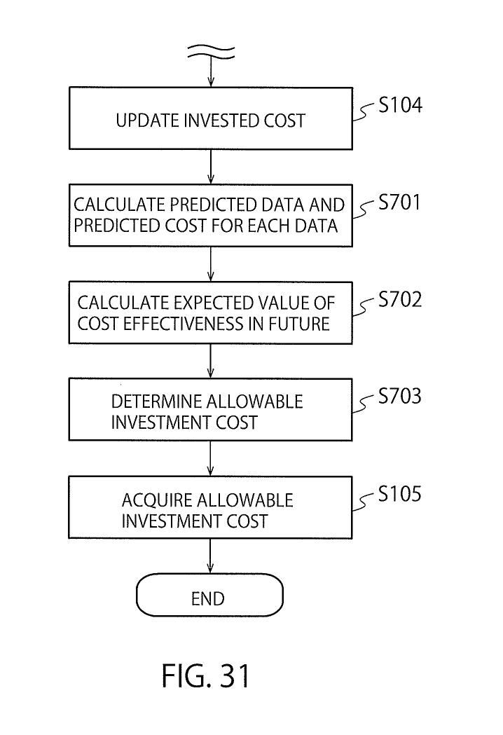

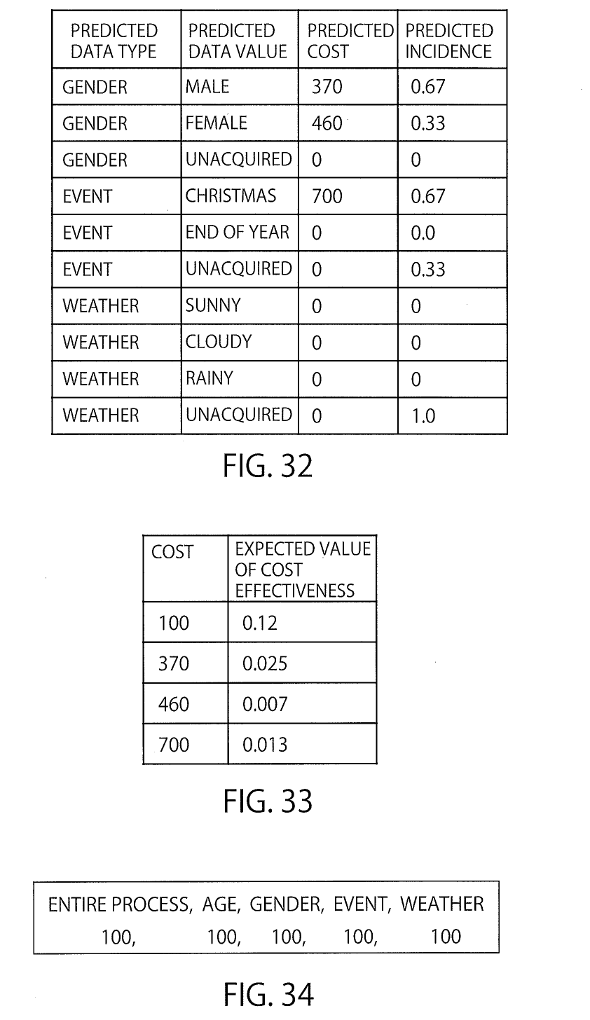

Next, a flow of processing performed in the seventh embodiment will be described with reference to FIG. 31. FIG. 31 is a flowchart illustrating an example of a part of the flow of processing performed according to the seventh embodiment. The information processing apparatus 1 of the seventh embodiment performs processing in FIG. 31 that is the replacement of the processing performed in steps S104 and S105 of the first embodiment illustrated in FIG. 8. The flow of the processing will now be described by using specific data as an example. Here, FIG. 31 and a range related thereto will be described while omitting description of the flow of overall processing that is the same as that of the first embodiment. FIG. 32 is a table illustrating an example of a pair of the predicted cost and the predicted incidence when age data “70” is acquired as the acquired data. FIG. 33 is a table illustrating an example of a pair of the cost and the expected vale of cost effectiveness when the age data “70” is acquired as the acquired data.

FIG. 34 is a table illustrating an example of the allowable investment cost according to the seventh embodiment. Next, the flow of processing will be described together with the flow of data collection by using FIGS. 31 to 34.

The cost effectiveness predictor 48 uses the past acquired data in the past content distribution recorded in the data storage 21 and the past acquisition cost stored in the cost storage 23 to determine, for each unacquired data, a predicted cost that is the prediction of a cost required to acquire the unacquired data and a predicted incidence that is the prediction of an incidence of the unacquired data (step S701).

In the present embodiment, as an example, the cost effectiveness predictor uses the past acquisition cost stored in the cost storage 23 illustrated in FIG. 18 and the past acquired data stored in the data storage 21 illustrated in FIG. 20 to predict, for each of age data, gender data, event data, and weather data, a value of the data and a cost required to acquire the data. The cost effectiveness predictor 48 in this case performs two compilation for the range including data corresponding with the acquired data among the data acquired in the past content distribution, for example. For each pair of the data type and the data value, the cost effectiveness predictor 48 determines as the predicted incidence an incidence of the value assuming a condition that the acquired data is acquired. For each pair of the type and value of the predicted data, the cost effectiveness predictor 48 determines as the predicted cost an average of the past acquisition cost required to acquire predicted data in the past when the acquired data is acquired.

When the age data “70” is acquired as the acquired data, for example, the cost effectiveness predictor 48 uses the past acquired data (refer to FIG. 20) including the age data “70” and the corresponding cost (refer to FIG. 18) to determine, as the predicted cost, an average of the past acquisition cost required to acquire the predicted data in the past when the age data “70” is acquired and determine, as the predicted incidence, a conditional incidence of the value when the age data “70” is acquired. The cost effectiveness predictor 48 then saves in the storage 2 the pair of the type and value of the predicted data in association with the predicted cost and the predicted incidence, as illustrated in FIG. 32.

The cost effectiveness predictor 48 calculates the expected value of the cost effectiveness by using the acquired data recorded in the data storage 21, the past acquisition cost recorded in the cost storage 23, and the predicted cost and predicted incidence determined for the unacquired data in step S701 (step S702).

For each pair of the type and value of the predicted data associated with a predicted cost larger than zero in FIG. 32, the cost effectiveness predictor 48 of the present embodiment calculates an average of the effect information of past distribution in which a content is distributed by acquiring the acquired data and the predicted data. Here, the predicted data is identified by the type and value of the predicted data. The cost effectiveness predictor 48 then obtains the expected value of the cost effectiveness by dividing the calculated average of the effect information by an average of the past acquisition cost required to acquire the predicted data in the past and multiplying the outcome by the conditional incidence of the predicted data when the acquired data is acquired.

Specifically, the cost effectiveness predictor 48 calculates the expected value of the cost effectiveness according to the following procedure. The cost effectiveness predictor 48 first calculates the expected value of the cost effectiveness at a point when the acquired data is acquired (hereinafter referred to as current cost effectiveness). In order to calculate the expected value of the current cost effectiveness, distribution IDs “9999”, “9996”, and “9995” are acquired from the past content distribution data that is the age data “70” (refer to FIG. 20). An average of these effect information is calculated to be 12.667 (=(8+20+10)/3) by using the effect information in FIG. 24, so that the cost effectiveness predictor 48 divides the average 12.667 of the effect information by the average 100 of the past acquisition cost required to acquire the age data “70” in the past (refer to FIG. 18), and obtains an expected value 0.12 (=12.667/100) of the cost effectiveness.

Next, the cost effectiveness predictor 48 calculates the expected value of the cost effectiveness in order from the top row of the table illustrated in FIG. 32 for each case where each of the predicted data is acquired. First, for gender data “male” in the first row of FIG. 32, the cost effectiveness predictor 48 acquires the distribution IDs “9999” and “9996” identifying the past content distribution including the age data “70” and the gender data “male” in the past acquired data (refer to FIG. 20). An average of these effect information is calculated to be 14 (=(8+20)/2) (refer to FIG. 24), which is multiplied by the incidence thereof 0.67 and divided by an average of the past acquisition cost 370 (=(400+340)/2) required to acquire the gender data “male” when the age data “70” is acquired in the past, so that an expected value 0.025 (=14×0.67/370) of the cost effectiveness is obtained. Similarly, the cost effectiveness predictor 48 acquires an expected value of the cost effectiveness 0.007 when gender data “female” is acquired at a point where the cost is 460 and an expected value of the cost effectiveness 0.013 when event data “Christmas” is acquired at a point where the cost is 700. The cost effectiveness predictor 48 thereafter puts these values together and records in the storage 2 the cost in association with the expected value of the cost effectiveness as illustrated in FIG. 33.

The allowable investment cost determiner 46 determines the allowable investment cost by referring to the result of step S702 (step S703). In the present embodiment, the allowable investment cost determiner 46 determines, as the allowable investment cost for the entire process and each data, a cost with the highest expected value of the cost effectiveness among the expected values of the cost effectiveness acquired in step S702, for example. In the example illustrated in FIG. 33, a cost 100 has the highest expected value of the cost effectiveness so that the allowable investment costs equal “100, 100, 100, 100, 100” as illustrated in FIG. 34.

Next, an overview of the whole processing will be described.

When the age data “70” is acquired 100 milliseconds after a membership card is read by a card reader (step S101), for example, the age data “70” is recorded in the data storage 21 as first acquired data, as illustrated in FIG. 11A (step S102).

The invested costs are updated to “100, 100, 100, 100, 100” as illustrated in FIG. 12A (step S104).

The allowable investment costs are then determined to be “100, 100, 100, 100, 100” as illustrated in FIG. 34 by the processing performed in steps S701 to S703 described above.

Next, in step S106, a discontinuation determiner 43 compares the invested cost at this point with the corresponding allowable investment cost (refer to FIG. 34), and returns the processing to step S104 to continue data collection since the invested costs for the entire process and the unacquired gender data, event data and weather data do not exceed the corresponding allowable investment costs.

When it is 101 milliseconds after the membership card is read by the card reader, the invested costs are updated to “101, 100, 101, 101, 101” with the acquired data unchanged as illustrated in FIG. 11A (step S104).

Next, in step S106, the discontinuation determiner 43 compares the invested cost at this point with the corresponding allowable investment cost (refer to FIG. 34), and transmits a discontinuation signal to a content determiner 44 to discontinue the data collection since the invested costs for the entire process and the unacquired gender data, event data and weather data all exceed the corresponding allowable investment costs (step S107).

Through the aforementioned processes, in the present embodiment, the content is determined and distributed 101 milliseconds after the membership card of a shopper is read by the card reader.

The cost effectiveness predictor 48 in the seventh embodiment uses the acquired data that is a piece of data already acquired, the past acquired data acquired by the data collector 41 for the past content distribution, the past acquisition cost required to acquire the past acquired data, and the corresponding effect information and, for each predicted data that is to be possibly acquired, determines the predicted cost and the expected value of cost effectiveness when the predicted data is acquired, the predicted cost being the predicted value of the cost required to acquire the predicted data when data identical to the acquired data is acquired. Then, the allowable investment cost determiner 46 determines the allowable investment cost by using the predicted cost and the expected value of the cost effectiveness.

Accordingly, the expected values of the cost effectiveness are compared to be able to determine the allowable investment cost on the basis of the cost expected to have the highest cost effectiveness. As a result, one can expect the effect of increased cost effectiveness in the long run compared to the sixth embodiment.

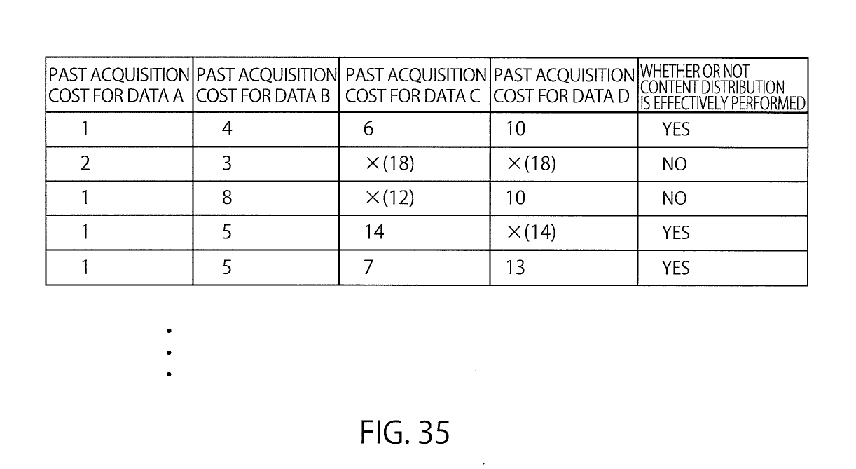

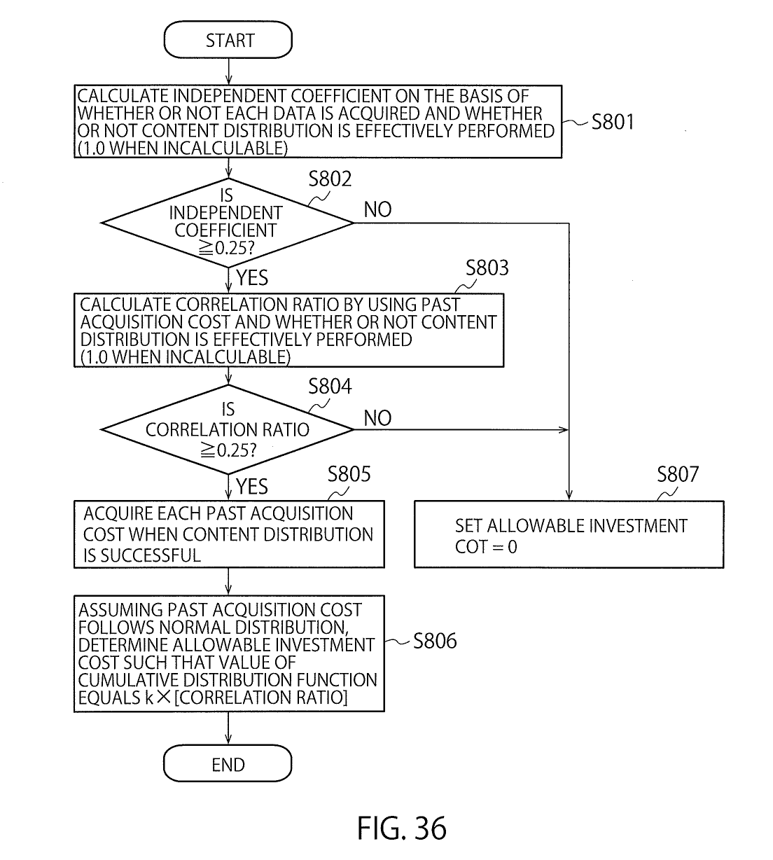

When a track record of the past content distribution is provided as illustrated in FIG. 35, the allowable investment cost determiner 46 may determine the allowable investment cost according to a flow of processing illustrated in FIG. 36.

FIG. 35 is a table illustrating an example of the track record of the past content distribution. FIG. 35 illustrates a set of a past acquisition cost for data A, a past acquisition cost for data B, a past acquisition cost for data C, a past acquisition cost for data D and whether or not the content distribution is effectively performed. In the table, “x” indicates that the data cannot be acquired while a number in parentheses next to “x” indicates a cost invested at that time. For example, “x (18)” indicates that corresponding data cannot be acquired when the cost of 18 is invested.

Under the column indicating whether or not the content distribution is effectively performed, “Yes” means the content distribution is effectively performed against a target of distribution while “No” means the content distribution is not effectively performed against the target of distribution.

FIG. 36 is a flowchart illustrating an example of processing which determines the allowable investment cost while factoring in the effect of distribution.

First, the allowable investment cost determiner 46 calculates an independent coefficient on the basis of whether or not each data is acquired in the past content distribution and whether or not the content distribution is effectively performed (step S801). The allowable investment cost determiner 46 sets the independent coefficient to 1.0 when the independent coefficient cannot be calculated.

Next, the allowable investment cost determiner 46 determines whether or not the independent coefficient is larger than or equal to a threshold 0.25 (step S802). Note that the threshold 0.25 is set as an example and may be set to another value.

When the independent coefficient is determined to be larger than or equal to the threshold 0.25 in step S802, it is considered that there is a relation between whether or not the data is acquired and whether or not the distribution is effectively performed so that the allowable investment cost determiner 46 calculates a correlation ratio on the basis of the past acquisition cost for each data in the past content distribution and whether or not the content distribution is effectively performed (step S803). The allowable investment cost determiner 46 sets the correlation ratio to 1.0 when the correlation ratio cannot be calculated.

Next, the allowable investment cost determiner 46 determines whether or not the correlation ratio is larger than or equal to a threshold 0.25 (step S804). Note that the threshold 0.25 is set as an example and may be set to another value.

When the correlation ratio is determined to be larger than or equal to the threshold 0.25 in step S804, it is considered that there is a correlation between the past acquisition cost for each data in the past content distribution and whether or not the content distribution is effectively performed so that the allowable investment cost determiner 46 acquires each past acquisition cost when the content distribution is successfully performed (step S805).

Where the past acquisition cost is assumed to follow a normal distribution, the allowable investment cost for each data is determined such that a cumulative distribution function of the corresponding past acquisition cost equals a specified coefficient k (such as 0.8)×the correlation ratio (step S806).

When the independent coefficient is determined to be smaller than the threshold 0.25 in step S802, there is no relation between whether or not each data is acquired in the past content distribution and whether or not the content distribution is effectively performed (step S807). When the correlation ratio is determined to be smaller than the threshold 0.25 in step S804, there is no correlation between the past acquisition cost for each data in the past content distribution and whether or not the content distribution is effectively performed. In these cases, the allowable investment cost determiner 46 sets the allowable investment cost for each data to zero.

The allowable investment cost determiner 46 calculates the independent coefficient on the basis of whether or not each data is acquired in the past content distribution and whether or not the content distribution is effectively performed, calculates the correlation ratio on the basis of the past acquisition cost for each data in the past content distribution and whether or not the distribution is effectively performed when the independent coefficient exceeds a first threshold, and determines the allowable investment cost when the correlation ratio exceeds a second threshold, as described above.

The allowable investment cost can thus be determined when there is a relation between whether or not each data is acquired in the past content distribution and whether or not the content distribution is effectively performed and when there is a correlation between the past acquisition cost for each data in the past content distribution and whether or not the content distribution is effectively performed.

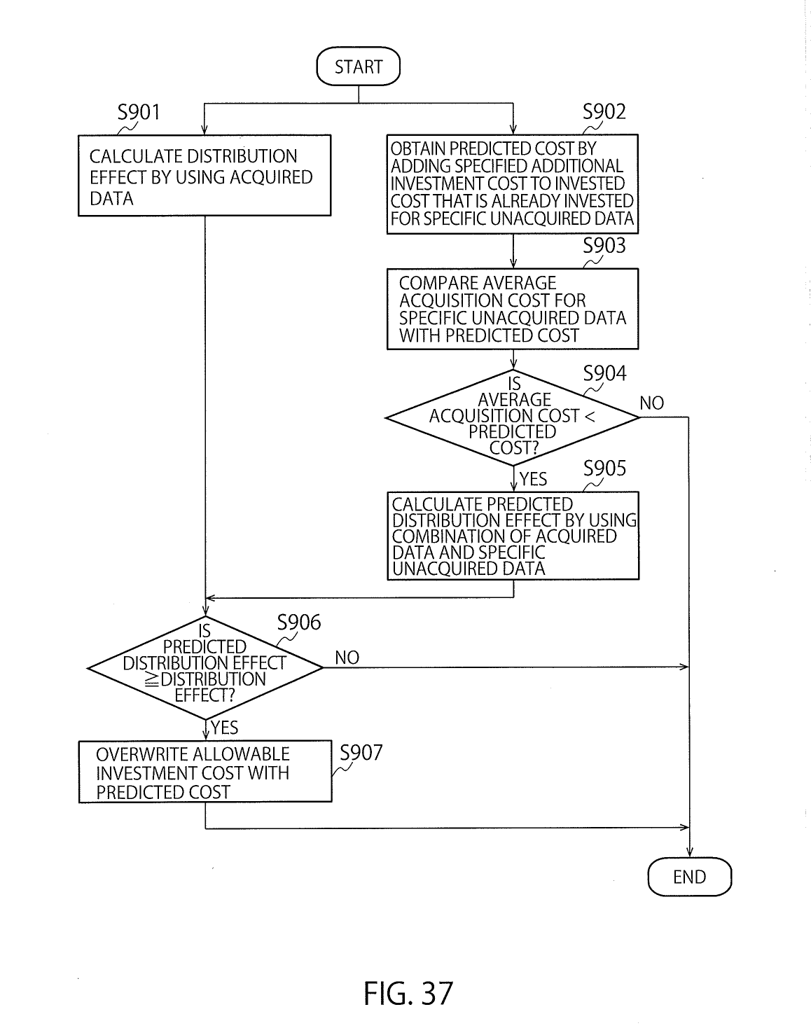

Moreover, the allowable investment cost determiner 46 may determine the allowable investment cost according to a flow of processing illustrated in FIG. 37. FIG. 37 is a flowchart illustrating an example of processing which determines the allowable investment cost while factoring in the acquired data. This processing assumes a case where a specific unacquired data is likely to be acquired when further investing a specified additional investment cost. When a predicted distribution effect is higher than or equivalent to a distribution effect, the allowable investment cost determiner 46 updates the allowable investment cost in order to wait for data until a specified additional investment cost is further invested.

First, the allowable investment cost determiner 46 uses the acquired data and calculates the distribution effect of a content determined on the basis of the acquired data (step S901). The distribution effect is an average of the effect information in the past content distribution for which the acquired data is acquired, for example.

In parallel with step S901, the allowable investment cost determiner 46 performs processing in each of steps S902 to S905 as follows.

The allowable investment cost determiner 46 acquires the predicted cost by adding the specified additional investment cost to the invested cost that is already invested to specific unacquired data (step S902).

Next, the allowable investment cost determiner 46 calculates, as an average acquisition cost, an average of the past acquisition cost of the specific unacquired data for the past content distribution in which data identical to the acquired data is acquired and in which the specific unacquired data is successfully acquired (step S903). The average acquisition cost for the specific unacquired data and the predicted cost acquired in step S902 are compared.

After that, the allowable investment cost determiner 46 determines from the comparison whether or not the average acquisition cost for the specific unacquired data is smaller than the predicted cost (step S904). The allowable investment cost determiner 46 ends the processing when the average acquisition cost for the specific unacquired data is determined to be larger than or equal to the predicted cost in step S904.

When the average acquisition cost for the specific unacquired data is determined to be smaller than the predicted cost in step S904, the allowable investment cost determiner 46 uses the combination of the acquired data and the specific unacquired data to calculate the predicted distribution effect that is a predicted value of the distribution effect of a content determined on the basis of the combination (step S905). The predicted distribution effect is an average of the effect information in the past content distribution for which the acquired data and the specific unacquired data are acquired, for example.

The allowable investment cost determiner 46 determines whether or not the predicted distribution effect calculated in step S905 is higher than or equivalent to the distribution effect calculated in step S901 (step S906). The allowable investment cost determiner 46 ends the processing when the predicted distribution effect is lower than the distribution effect.

When the predicted distribution effect is determined to be higher than or equivalent to the distribution effect in step S906, the allowable investment cost is overwritten with the predicted cost acquired in step S902 (step S907).

As a result, when the predicted distribution effect of the content determined after acquiring the specific unacquired data is higher than the distribution effect of the content determined by using the acquired data, the information processing apparatus 1 can wait for the specific unacquired data to be acquired until the specified additional investment cost is further invested from that point.

As described above, the allowable investment cost determiner 46 determines whether or not to acquire the specific unacquired data by further investing the specified additional investment cost while using the invested cost that is already invested to acquire the specific unacquired data and the past acquisition cost therefor and, when determining to acquire the specific unacquired data by further investing the additional investment cost, determines whether or not the distribution effect of the content increases when the specific unacquired data is further acquired by using first effect information pertaining to the effect of past content distribution for which data including a pair of the acquired data that is already acquired and the specific unacquired data are acquired as well as using second effect information pertaining to the effect of past content distribution for which data including the acquired data is acquired, and then increases the allowable investment cost by the amount of the specified additional investment cost when determining that the distribution effect of a content increases.

The information processing apparatus 1 can therefore wait for the specific unacquired data to be acquired until the specified additional investment cost is further invested from that point, when the distribution effect of a content is highly likely to be increased upon further investing the specified additional investment cost. One can thus expect the effect of increased cost effectiveness as the distribution effect of a content is expected to be increased with a small cost.

Moreover, it may be adapted to record a program used to execute each processing of the information processing apparatus 1 of each embodiment in a computer-readable recording medium, cause a computer system to read the program recorded in the recording medium as well as cause a processor to execute the program, and perform the aforementioned processings according to the information processing apparatus 1 of each embodiment.

Note that the “computer system” may include an OS and hardware such as peripherals. The “computer system” also includes an environment in which a home page is provided (or displayed) when a WWW system is used. Moreover, the “computer-readable recording medium” refers to a storage such as a writable non-volatile memory including a flexible disk, a magneto-optical disk, a ROM, and a flash memory, a portable medium such as a CD-ROM, and a hard disk built-in into the computer system.

The “computer-readable recording medium” also includes ones holding a program for a fixed period of time such as a volatile memory (such as a DRAM (Dynamic Random Access Memory)) provided in the computer system to be a server or client when the program is transmitted through a network such as the Internet or a communication line such as a telephone line. The program may also be transmitted from the computer system, which stores the program in the storage or the like, to another computer system through a transmission medium or by a transmission wave in the transmission medium. Here, the “transmission medium” transmitting the program refers to a medium such as the network (communication network) including the Internet and the communication line including the telephone line that have a function of transmitting information. The program may be provided to realize a part of the aforementioned function. Furthermore, the program may be a so-called differential file (differential program) that can realize the aforementioned function in combination with the program already recorded in the computer system.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus comprising:
a data collector which collects a plurality of pieces of data;
a discontinuation determiner which, for each data or entire processing of collecting the plurality of pieces of data, compares an invested cost that is already invested for data collection with an allowable investment cost that is an upper limit of a cost allowed to be invested for the data collection and determines to discontinue the data collection according to a result of the comparison; and
a content determiner which uses data collected by the data collector up to a point the discontinuation is determined and determines information related to a content to be distributed when the discontinuation determiner determines to discontinue the data collection.

2. The apparatus according to claim 1, wherein the information related to the content is at least one of a content, a way the content is distributed, and a way the content is displayed.

3. The apparatus according to claim 1, wherein the allowable investment cost is set for each of the plurality of pieces of data, and the discontinuation determiner compares, for each data, the invested cost that is already invested for the data collection with the allowable investment cost set for the data.

4. The apparatus according to claim 1, further comprising an allowable investment cost determiner which determines the allowable investment cost by using the invested cost that is already invested for the data collection.

5. The apparatus according to claim 1, further comprising an allowable investment cost determiner which determines the allowable investment cost by using a past acquisition cost that is a cost required for data acquisition in past content distribution.

6. The apparatus according to claim 5, wherein the allowable investment cost determiner determines the allowable investment cost for each type of the data.

7. The apparatus according to claim 1, further comprising an allowable investment cost determiner which determines the allowable investment cost by using acquired data that is a piece of data already acquired, past acquired data that is data acquired by the data collector to execute past content distribution, and a past acquisition cost that is a cost required to acquire the past acquired data.

8. The apparatus according to claim 7, wherein the allowable investment cost determiner collects the past acquisition cost in past content distribution including data that has the same type and value as the acquired data, and determines the allowable investment cost by using the past acquisition cost collected.

9. The apparatus according to claim 1, further comprising:
an effect acquisitor which acquires effect information related to an effect of past content distribution; and
an allowable investment cost determiner which determines the allowable investment cost by using a past acquisition cost that is a cost required for the data collector to acquire data to execute the past content distribution and effect information related to an effect of the past content distribution.

10. The apparatus according to claim 9, wherein the allowable investment cost determiner identifies past content distribution to be used to determine the allowable investment cost on the basis of a pair of the past acquisition cost and a value of the effect information, and determines the allowable investment cost by using a past acquisition cost in the past content distribution identified.

11. The apparatus according to claim 1, further comprising:
an effect acquisitor which acquires effect information related to an effect of past content distribution; and
an allowable investment cost determiner which determines the allowable investment cost by using the acquired data that is already acquired, past acquired data that is acquired by the data collector to execute past content distribution, a past acquisition cost that is a cost required to acquire the past acquired data, and the corresponding effect information.

12. The apparatus according to claim 11, wherein the allowable investment cost determiner determines the allowable investment cost by identifying the past acquired data including data that has the same type and value as the acquired data, collecting the past acquisition cost in past content distribution used to determine the allowable investment cost by using the past acquisition cost in the past content distribution identified and the corresponding effect information, and using the past acquisition cost collected.

13. The apparatus according to claim 1, further comprising:
an effect acquisitor which acquires effect information related to an effect of past content distribution;
a cost effectiveness predictor which uses acquired data that is a piece of data already acquired, past acquired data acquired by the data collector to execute past content distribution, a past acquisition cost required to acquire the past acquired data, and the corresponding effect information and, for each predicted data that is to be possibly acquired, determines a predicted cost and an expected value of cost effectiveness when the predicted data is acquired, the predicted cost being an predicted value of a cost required to acquire the predicted data when data identical to the acquired data is acquired; and
an allowable investment cost determiner which determines the allowable investment cost by using the predicted cost and the expected value of the cost effectiveness.

14. The apparatus according to claim 13, wherein the cost effectiveness predictor determines, for each predicted data, the expected value of the cost effectiveness by using effect information acquired in past content distribution for which the predicted data is acquired in addition to the acquired data, the predicted cost, and a predicted incidence which is a probability that the predicted data is to be acquired when data identical to the acquired data is acquired.

15. The apparatus according to claim 13, wherein the allowable investment cost determiner compares the expected values of the cost effectiveness and determines a cost according to a comparison result as the allowable investment cost.

16. The apparatus according to claim 1, further comprising an allowable investment cost determiner which calculates an independent coefficient on the basis of whether or not each data is acquired in past content distribution and whether or not the content distribution is effectively performed, calculates a correlation ratio on the basis of a past acquisition cost for each data in the past content distribution and whether or not the distribution is effectively performed when the independent coefficient exceeds a first threshold, and determines the allowable investment cost when the correlation ratio exceeds a second threshold.

17. The apparatus according to claim 1, further comprising an allowable investment cost determiner which determines whether or not to acquire specific unacquired data by further investing a specified additional investment cost while using an invested cost that is already invested to acquire the specific unacquired data and a past acquisition cost for the specific unacquired data and, when determining to acquire the specific unacquired data by further investing the additional investment cost, determines whether or not a distribution effect of a content increases when the specific unacquired data is further acquired by using first effect information pertaining to an effect of past content distribution for which data including a pair of the acquired data that is already acquired and the specific unacquired data are acquired as well as using second effect information pertaining to an effect of past content distribution for which data including the acquired data is acquired, and then increases the allowable investment cost by the amount of the specified additional investment cost when determining that the distribution effect of a content increases.

18. The apparatus according to claim 1, wherein the data corresponds to any of an attribute of a person to whom a content is distributed, an event related to a time point when the data is acquired, and weather at a time point when the data is acquired.

19. An information processing method comprising the steps in which:
a data collector collects a plurality of pieces of data;
a discontinuation determiner compares, for each data or entire processing of collecting the plurality of pieces of data, an invested cost that is already invested for data collection with an allowable investment cost that is an upper limit of a cost allowed to be invested for the data collection and determines to discontinue the data collection according to a result of the comparison; and
a content determiner uses data collected by the data collector up to a point the discontinuation is determined and determines information related to a content to be distributed when the discontinuation determiner determines to discontinue the data collection.

20. A computer-readable recording medium recording a program which causes a computer to function as:
a data collector which collects a plurality of pieces of data;
a discontinuation determiner which, for each data or entire processing of collecting the plurality of pieces of data, compares an invested cost that is already invested for data collection with an allowable investment cost that is an upper limit of a cost allowed to be invested for the data collection and determines to discontinue the data collection according to a result of the comparison; and
a content determiner which uses data collected by the data collector up to a point the discontinuation is determined and determines information related to a content to be distributed when the discontinuation determiner determines to discontinue the data collection.
